(19) United States
(12) Patent Application Publication
(10) Pub. No.: US 2013/0179177 A1
(43) Pub. Date: Jul. 11, 2013

(54) Method and Apparatus for Quality Control of Electronic Interactions Between Pharmacies and Prescribers

(71) Applicants: Ajit A. Dhavle, Alexandria, VA (US); David Yakimischak, Brookside, NJ (US)

(72) Inventors: Ajit A. Dhavle, Alexandria, VA (US); David Yakimischak, Brookside, NJ (US)

(73) Assignee: Surescripts

(21) Appl. No.: 13/344,332

(22) Filed: Jan. 5, 2012

(51) Int. Cl. G06Q 50/22

(52) U.S. Cl. 705/2

(57) ABSTRACT

A computer system, computer readable memory, and a method for quality control checking, where the method comprises the steps of determining an interaction between a pharmacy and a prescriber; evaluating the interaction for each of a plurality of quality issues; and generating a quality report card to indicate the results of evaluating the interaction for each of the plurality of quality issues. The interaction may include one or more of a refill request, a refill response, an original prescription, and a new prescription.

### FIELD

The present disclosure relates to quality control checking and more particularly to quality control checking of electronic interactions between pharmacies and prescribers when a pharmacy has requested a refill of prescription issued by the prescriber.

### BACKGROUND

In the discussion of the background that follows, reference is made to certain structures and/or methods. However, the following references should not be construed as an admission that these structures and/or methods constitute prior art. Applicants expressly reserve the right to demonstrate that such structures and/or methods do not qualify as prior art.

When a prescriber such as a doctor sends a prescription to a pharmacy electronically, this is often called electronic prescribing of pharmaceuticals. The doctor may have a software program from a technology vender that assists the doctor in filling out the prescription and which electronically sends the electronic prescription to a pharmacist. The pharmacist may have a software program from the same or a different technology vender that receives the electronic prescription and notifies the pharmacist to fulfill the prescription. The patient may pick up the prescription medication from the pharmacist without having to give the pharmacist the prescription.

Electronic prescribing of pharmaceuticals improves the productivity of the doctor, the pharmacy, and the patient. The doctor's productivity may be improved because the software helps the doctor fill out the prescription and sends the prescription to the pharmacy. The pharmacy's productivity may be improved because the pharmacy may receive a legible prescription that does not need to be confirmed with the doctor. The patient's productivity may be improved because the patient does not have to give the prescription to the pharmacy and the patient may not have to wait at the pharmacy for the prescription to be filled. Additionally, all may benefit by better automated record keeping, which may help prevent errors.

A patient may come to a pharmacy and request a refill of a prescription when the original prescription does not authorize refills or when the original prescription expires, or when there are no refills remaining on the original prescription. FIG. 1 illustrates an interaction between a pharmacy 152 and a prescriber 154 where the pharmacy 152 requests from the prescriber 154 permission to refill an original prescription that does not authorize the pharmacy 152 to refill the original prescription because, for example, the original prescription is expired and thus needs renewed authorization from the prescriber 154. The interaction between the pharmacy 152 and the prescriber 154 proceeds as follows. The pharmacy 152 sends an electronic refill request 112 to the prescriber 154. The prescriber 154 responds to the electronic refill request 112 with an electronic refill response 114. If the prescriber 154 responds with an electronic refill response 114 that approves the electronic refill request 112, then the pharmacy 152 can fulfill the prescription for the patient.

The ability of the pharmacy 152 to electronically send an electronic refill request 112 to the prescriber 154 improves the productivity of the pharmacy 152, the prescriber 154, and the patient, for similar reasons as given above for the ability of the prescriber 154 to electronically send a prescription to the pharmacy 152. Refill requests 112 are not legal prescription documents, but an approved refill response 114 is generally treated as a legitimate new prescription 116 by a pharmacy 152.

In sending an electronic refill request 112, the goal of the pharmacy 152 is to convey the patient's medication requirements. In responding to the refill request 112, the goal of the prescriber 154 is to communicate their therapeutic intent back in an accurate, understandable, complete, unambiguous, timely and efficient manner.

For the patient's health it is critical that the patient's medication requirements are accurately conveyed to the prescriber 154 and that the therapeutic intent of the prescriber 154 are accurately conveyed to the pharmacy 152 in a timely manner. However, prescriptions can be complicated with many data fields, and the pharmacy 152 may have one technology vendor for sending and receiving electronic messages whereas the prescriber 154 may have another technology vendor for sending and receiving electronic messages.

### SUMMARY

Therefore there is a need in the art for a system, computer readable medium, and a method for quality control checking, the method comprising: determining an interaction between a pharmacy and a prescriber; evaluating the interaction for each of a plurality of quality issues; and generating a quality report card to indicate the results of evaluating the interaction for each of the plurality of quality issues.

Determining an interaction may include selecting an electronic refill request originating from a pharmacy; searching for an electronic response originating from a prescriber that matches the retrieved electronic refill request; and if there is a matching electronic response, then the selected electronic refill request and the matching electronic response are the interaction, otherwise the electronic refill request is the interaction.

If there is a matching electronic response and the matching electronic response indicates a denial of the initial pharmacy refill request with a new prescription to follow, then the following steps may be performed: searching for an electronic new prescription corresponding to the electronic refill request, and if there is an electronic new prescription corresponding to the electronic refill request, then the selected electronic refill request, the matching electronic response, and the electronic new prescription corresponding to the electronic refill request are the interaction, otherwise the selected electronic refill request and the matching electronic response are the interaction.

The interaction may include an electronic refill request that comprises a free text description field and a drug strength field, and one of the plurality of quality issues may be whether or not the drug strength field matches a drug strength in the free text drug description field.

The method may include verifying that the drug strength field matches the drug strength in the free text drug description field; and generating may include generating the quality report card to indicate whether or not the drug strength field matches the drug strength in the free text drug description field.

The interaction may include an electronic refill request that includes a sender message identification, and a refill response that includes the sender message identification and a request approval status, and one of the plurality of quality issues may be whether or not the request approval status of the refill response is valid.

The method may include evaluating whether or not the request approval status is valid; and generating a quality report card may include generating a quality report card to indicate whether or not the request approval status is valid.

The interaction may include an electronic refill request including a sender message identification and one or more fields that must be echoed back, and a electronic refill response may include the sender message identification, and one of the plurality of quality issues may be whether or not the electronic refill response echoes back the fields that must be echoed back.

The method may include evaluating whether or not the refill response echoes back the one or more fields that must be echoed back; and generating a quality report card may include generating a quality report card to indicate whether or not the refill response echoes back the one or more fields that must be echoed back.

The electronic refill response may include a request approval status, and the one or more fields that must be echoed back may be based on the request approval status.

The interaction may include an electronic refill response including one or more fields that are required, and one or more of the plurality of quality issues may be whether or not the electronic refill response meets one or more quality issue for the one or more fields that are required.

The method may include evaluating whether or not the electronic refill response meets one or more quality issues for the one or more fields that are required; and generating a quality report card may include generating a quality report card to indicate whether or not the electronic refill response meets one or more quality issue for the one or more fields that are required.

The electronic refill response may include a request approval status, and the one or more fields that are required may be based on the request approval status.

The interaction may include an electronic refill request including a sender message identification, and a electronic refill response including the sender message identification and one or more fields that are changed from the electronic refill request or fields not part of the refill request, and one of the plurality of quality issues may be whether or not the one or more fields that are changed from the electronic refill request or fields not part of the refill request meet one or more quality issues.

The method may include evaluating whether or not the one or more fields that are changed from the electronic refill request or fields not part of the refill request meet one or more quality issues; and generating a quality report card may include generating a quality report card to indicate whether or not the one or more fields that are changed from the electronic refill request or fields not part of the refill request meet one or more quality issues.

The one or more fields that are required may include a substitutions allowed field, and evaluating whether or not the refill response meets one or more quality issues for the one or more fields that are required, may include evaluating whether or not the substitution allowed field contains a valid value; and generating a quality report card further may include generating a quality report card to indicate whether or not the substitution allowed field contains a valid value.

Evaluating may include evaluating the interaction for each of a plurality of quality issues, and for at one of the plurality of quality issues, evaluating whether or not the interaction meets a quality standard; and generating a quality report card to indicate the results of evaluating the interaction for each of the plurality of quality issues, and to indicate whether or not the interaction meets a quality standard.

Determining may include determining interactions that comprise a report target party; and, evaluating may include evaluating the determined interactions for each of a plurality of quality issues; and generating may include generating a quality report card to indicate the results of evaluating the determined interactions for each of the plurality of quality issues, wherein the report target party is at least one of a pharmacy, a prescriber, a pharmacy technology vender, or a prescriber technology vender.

Determining may include determining interactions that comprise a report target party for a date range.

A non-transitory computer program product is disclosed. The non-transitory computer program product includes a computer usable medium having a computer readable program code embodied therein, said computer readable program code adapted to be executed to implement a method of quality control checking, said method may include determining an interaction between a pharmacy and a prescriber; evaluating the interaction for each of a plurality of quality issues; and generating a quality report card to indicate the results of evaluating the interaction for each of the plurality of quality issues.

A computer system for quality control checking is disclosed. The computer system for quality control checking may include a process adapted to: determine an interaction between a pharmacy and a prescriber; evaluate the interaction for each of a plurality of quality issues; and generate a quality report card to indicate the results of evaluating the interaction for each of the plurality of quality issues.

Determine an interaction may include select an electronic refill request originating from a pharmacy; search for an electronic response originating from a prescriber that matches the retrieved electronic refill request; and if there is a matching electronic response, then the selected electronic refill request and the matching electronic response are the interaction, otherwise the electronic refill request is the interaction.

The interaction may include an electronic refill response comprising one or more fields that are required, and one or more of the plurality of quality issues may be whether or not the electronic refill response meets one or more quality issue for the one or more fields that are required.

The process may be further adapted to: evaluate whether or not the electronic refill response meets one or more quality issues for the one or more fields that are required.

Generate a quality report card may include generate a quality report card to indicate whether or not the electronic refill response meets one or more quality issue for the one or more fields that are required.

The electronic refill response may include a request approval status, and the one or more fields that are required may be based on the request approval status.

### BRIEF DESCRIPTION OF THE DRAWING

The following detailed description can be read in connection with the accompanying drawings in which like numerals designate like elements and in which:

FIG. 1 illustrates an example of an interaction between a pharmacy and a prescriber;

FIG. 2 is an illustration of an example of a quality control system;

FIG. 3 illustrates an example of an interaction between a pharmacy and a prescriber;

FIG. 4 illustrates an example of a method of the quality control system;

FIG. 5 illustrates an example of a refill request;

FIG. 6 illustrates an example of a drug product database;

FIG. 7 illustrates an example of a synonym database;

FIG. 8 illustrates an example of a method to match an electronic prescription with a drug product in a drug product database in the reference sources;

FIGS. 9A and 9B illustrate an example of a method for evaluating a refill requests for a plurality of quality issues;

FIG. 10 illustrates an example of an refill response;

FIG. 11 illustrates an example of a method for evaluating a refill response for quality control;

FIGS. 12A and 12B are illustrations of examples of a quality report card; and

FIG. 13 is a simplified functional block diagram of a computer system.

### DETAILED DESCRIPTION

It is to be understood that both the foregoing general description and the following detailed description are exemplary and explanatory and are intended to provide further explanation of the invention as claimed.

Echo is meant to have its ordinary meaning to one skilled in the art, which is that a value in a request is sent back in a response with the same value. In embodiments, the value sent back in the response may be similar to the value sent in the request with some change to the value sent back in the response. Echo may refer to one or more values in a request being sent back in a response.

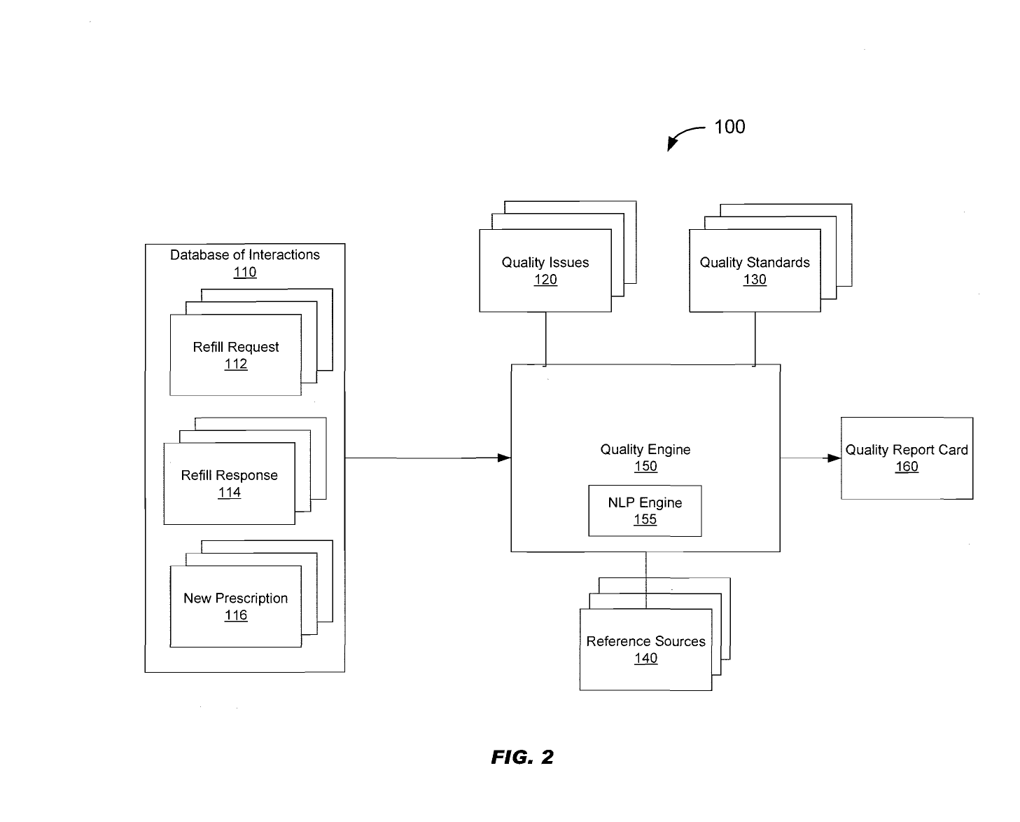

FIG. 2 is an illustration of an example of a quality control system 100. The quality control system 100 includes database of interactions 110, quality issues 120, optionally quality standards 130, reference sources 140, quality engine 150, and quality score card 160.

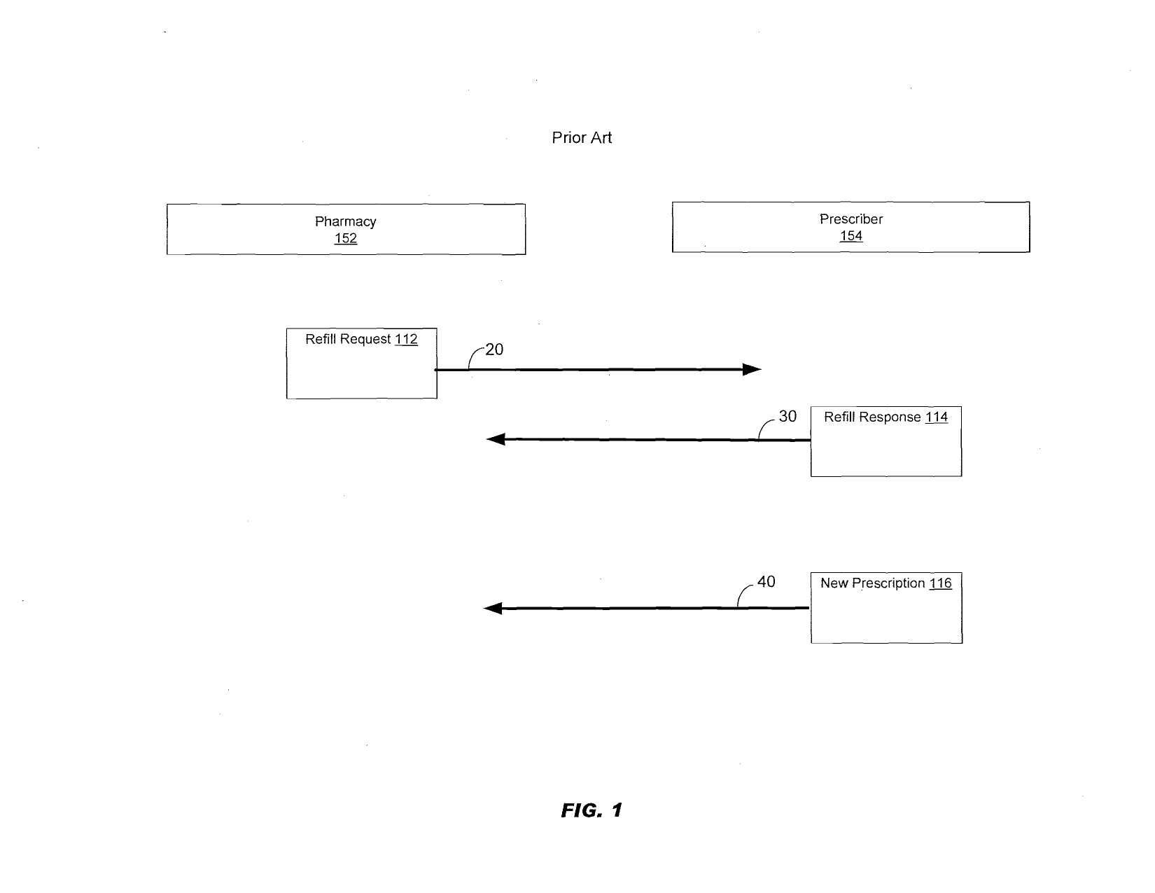

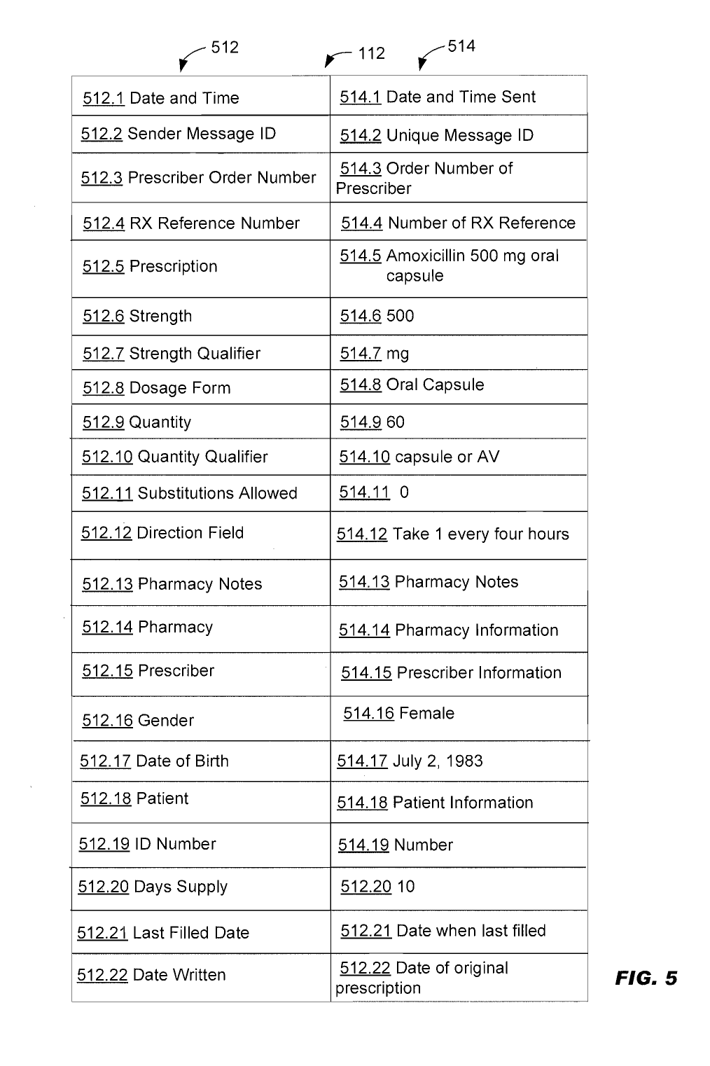

The quality engine 150 determines an interaction between a pharmacy 152 (see FIG. 1) and a prescriber 154, and then evaluates the interaction for a plurality of quality issues 120, and generates a quality report card 160 to indicate the result of evaluating the interaction for a plurality of quality issues 120. The quality engine 150 may include a natural language processing engine 155. The natural language processing engine 155 may be used to process natural language. For example, the NPL engine 155 may process the field pharmacy notes 514.13 (see FIG. 5).

The database of interactions 110 is a collection of data comprising refill requests 112, refill responses 114, and new prescriptions 116. The database of interactions 110 may be a flat file or may be organized. For example, the database of interaction 110 may be a relational database, or may be organized chronologically, or may have no organization beyond a collection of refill requests 112, refill responses 114, and new prescriptions 116. In embodiments, the database of interactions 110 does not include the new prescriptions 116.

The refill request 112, refill response 114, and new prescription 116 are a collection of data fields that may comprise a prescription, strength, strength qualifier, dosage form, quantity, quantity qualifier, generic substitution permitted, direction field, pharmacy notes, pharmacy, which may include demographic details of the pharmacy including the pharmacy name, prescriber, which may include demographic details of the prescriber including the prescriber name, gender patient, age of patient, and patient name. Some of the fields may be free form or written out by a prescriber and other fields may be chosen from a limited number of choices, for example from a pull down menu. The data fields are described in more detail below.

The quality issues 120 may comprise quality issues 120 that are specifically for the refill request 112, the refill response 114, the new prescription 116, or an interaction between a pharmacy 152 and prescriber 154.

The quality issues 120 may include whether or not a drug description field of the electronic prescription includes a drug name that can be matched to a drug product in a database of drug products in one of the reference sources 140. If a match can be found then additional fields of the matched drug product in the database of drug products may be used for additional quality issues. The matched drug product may include a National Drug Code (NDC) System 11-digit number that describes the drug product. The quality issues 120 may further include whether or not additional fields of the electronic refill request 112 are consistent with additional fields of the matched drug product. The quality issues 120 may further include whether or not the fields of the electronic prescription 110 are consistent with one another. The quality issues 120 may include whether or not the dosage form code field of the electronic refill request is consistent with the dosage form indicated within the drug description field on the electronic prescription message. The quality issues 120 may include whether or not a generic-brand field of the electronic refill request 112 is consistent with the drug name of the electronic refill request 112. The quality issues 120 may include whether or not the electronic refill request 112 is appropriate for the patient based on demographic information of the patient. Demographic information for the patient may be available either as part of the electronic refill request 112 or as part of the reference sources 140. The quality issues 120 may include whether or not pharmacy information included with the electronic refill request 112 is consistent with pharmacy information that is part of the reference sources 140. The quality issues 120 may include whether or not prescriber information included with the electronic refill response 114 is consistent with prescriber information that may be part of the reference sources 140. The quality issues 120 may include verifying that quantity and dosage information included with the electronic refill request 112 is consistent with quantity and dosage information for the drug product that is part of the references sources 140. The quality issues 120 may include verifying that a pharmacy notes field with the electronic refill response 114 is consistent with what a pharmacy notes field should contain based on information in the reference sources 140. In embodiments, the quality issues 120 may be separate rules that are read and interpreted by the quality engine 100. In embodiments, the quality issues 120 may be directly coded into the logic of the quality engine 100.

The quality standards 130, which are optional, are used to determine whether or not a refill request 112, refill response 114, and/or new prescription 116 satisfies quality issues 120. For example, a quality standard 130 may be that a new prescription 116 must match a drug product in the reference sources 140. Additional examples of quality standards 130 are provided below. In embodiments, the quality standards 130 may be separate rules that are stored in computer readable storage and read and interpreted by the quality engine 150. In embodiments, the quality standards 130 may be directly coded into the logic of the quality engine 150.

The reference sources 140 may include one or more databases of drug products that map drug products to the same unique clinical drug database identification, clinical support information, demographic information of pharmacies and pharmacy, demographic information of prescribers, demographic information of patients, and a synonym database. The reference sources 140 may be directly available or may be remotely accessible. For example, the reference sources 140 may be stored on a local computer hard drive or the reference sources 140 may be accessible over a computer network that may be either local or remote such as the Internet. The reference sources 140 may be accessed on a third party's local or remote computer readable storage device.

The quality report card 160 is data that indicates the result of evaluating the quality issues 120, and may, optionally, include applying the quality standards 130 to the quality issues 120. For example, the quality report card 160 may be data that indicates that a drug name of the new prescription 116 did not match a drug product in a drug product database of the reference sources 140. In this case the quality issue 120 is whether or not the drug name of the new prescription 116 matches a drug product in the drug product database of the reference sources 140, and the quality standard 130 is that the drug name of the new prescription 116 must match a drug product in the drug product database. The quality report card 160 is an indication that the new prescription 116 did not match a drug product in the drug product database.

Pharmacy 152 (see FIG. 1) is a place where the electronic prescription 110 may be sent and fulfilled. An example of a pharmacy 152 is a pharmacy or a pharmacy that is part of a superstore. Prescriber 154 is an entity that has the authority to authorize a refill request 112 and/or authorize a new prescription 116. An example of a prescriber 154 is a medical doctor.

In embodiments, the quality engine 150 is a computer module. The quality engine 150 may be a single computer module or a number of cooperating computer modules. The quality engine 150 may be configured to determine an interaction between a pharmacy 152 (see FIG. 1) and a prescriber 154, and then evaluate the interaction for a plurality of quality issues 120, and, optionally, evaluate whether or not the interaction meets a quality standard 130 for each of a plurality of quality issues 120, and the quality engine 150 may be configured to generate a quality report card 160 to indicate the result of evaluating the interaction for a plurality of quality issues 120, optionally, whether or not the interaction meets the quality standards 130 for each of the plurality of quality issues 120.

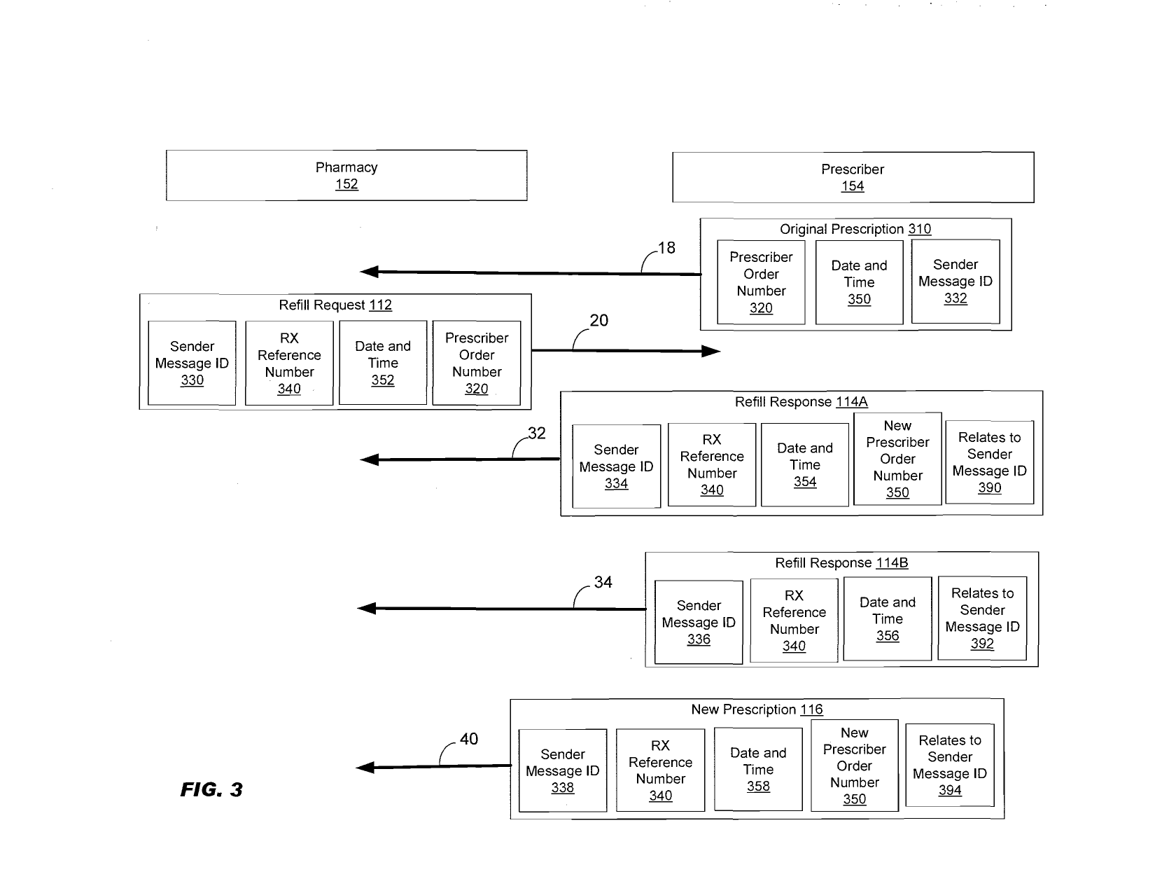

FIG. 3 illustrates an example of an interaction between a pharmacy 152 and a prescriber 154. Each of 112, 310, 114A, 114B, and 116 are messages. An original prescription 310 is sent to the pharmacy 152, which is indicated by arrow 18. The original prescription 310 may have been sent to the pharmacy 152 as a therapy for a patient from a prescriber 154. The original prescription 310 may include a Prescriber Order Number 320, a Date and Time 350, and a Sender Message ID 332. The Prescriber Order Number 320 may be used by the prescriber 154 to exactly match a message to the patient and medication entry in an automated system of the prescriber 154. The pharmacy 152 should echo back to the prescriber 154 the Prescriber Order Number 320 in the refill request 112. The pharmacy 152 may receive the original prescription 310 as a fax or piece of paper so that the original prescription 310 may not include the Prescriber Order Number 320 in which case the pharmacy 152 does not include the Prescriber Order Number in the refill request 112. Each of the messages may include a Date and Time 350, which indicates the date and time when the message is sent. Each of the messages may include a Sender Message ID 332, which may be required and may be a unique number that may be used to identify the message.

After the original prescription 310 was sent, the pharmacy 152 at some time sends to the prescriber 154 a refill request 112, which is indicated by arrow 20. The refill request 112 indicates that the patient would like to refill the original prescription 310, but that the original prescription 310 does not authorize the original prescription 310 to be refilled, or the refills have been expended, or it may be that the original prescription 310 has expired. For example, in many states a prescription is valid for only one year. The refill request 112 may include a Sender Message ID 330, an RX Reference Number 340, a Date and Time 352, and a Prescriber Order Number 320.

The Sender Message ID 330 is a message identification that may be generated by the pharmacy 152 to identify the refill request 112. The Sender Message ID 330 should be unique so that the pharmacy 152 can use the Sender Message ID 330 to uniquely identify the refill request 112. In embodiments, the Sender Message ID 330 is required for every message sent. The prescriber 116 may echo back the Sender Message ID 330 in the refill response 114A, 114B, and in a new prescription 116 when the new prescription 116 is in response to a denied refill request 112. In embodiments, the prescriber 116 is required to echo back the Sender Message ID 330 in the refill response 114A, 114B, and in a new prescription 116 when the new prescription 116 is in response to a denied refill request 112.

The RX Reference Number 340 is a reference number that may help the pharmacy 152 match the refill response 114A, 114B and/or the new prescription 116 to the patient medication history contained in an automated system of the pharmacy 152. The RX Reference Number 340 should be echoed back in the refill response 114A, 114B, and new prescription 116, by the prescriber 154.

The Date and Time 352 is the date and time when the refill request 112 is sent.

The Prescriber Order Number 320 is the Prescriber Order Number 320 that was sent in the original prescription 310 that may be used by the prescriber 154 to exactly match the refill request 112 to the patient and medication entry in an automated system of the prescriber 154. In embodiments, the Prescriber Order Number 320 may not be present in the refill request 112 because, for example, the original prescription 310 was received as a fax or piece of paper so that the original prescription 310 may not include the Prescriber Order Number 320.

The prescriber 154 receives the refill request 112 and responds to the refill request 112. The response will vary depending on the therapeutic intent of the prescriber 154. The National Council for Prescription Drug Programs (NCPDP) Script Standard provides guidelines for the interaction or protocol between the pharmacy 152 and the prescriber 154. In some embodiments, the refill response 114A, 114B may be one of four forms “A” for approval, “C” for approved with changes, “D” for denied, and “N” for denied with a new prescription to follow. In the case when the refill response 114 contains an “N”, then a new prescription 116 should follow.

Refill response 114A illustrates the case when the prescriber 154 has approved the refill request 112. In some protocols, an approval of a refill request 112 may be one of two types, an “A” for approval, and a “C” for approval with changes.

Refill response 114B illustrates the case when the prescriber 154 either denied the refill request 112, which may be indicated with a “D”, or the case where the prescriber 154 indicated that a new prescription 116 will follow, which may be indicated by an “N.”

New prescription 116 illustrates a new prescription 116 in the case when the refill response 114B indicated that a new prescription 116 would follow.

All of refill response 114A, refill response 114B, and new prescription 116 may include a Sender Message ID 334, 336, 338, RX Reference Number 340, and Data and Time 354. The Sender Message ID 330 is the Sender Message ID 330 included with the refill request 112. In embodiments, the Sender Message ID 330 of the Refill Request 112 is included in refill response 114A, 114B, and 116, as Relates to Sender Message ID 390, 392, 394. In embodiments, Relates to Sender Message ID 390, 392, 394 is a required field. The RX Reference Number 340 is sent by the pharmacy 152 and the prescriber 154 should echo back the RX Reference Number 340, which may help the pharmacy 152 match the refill response 114A, 114B to the patient medication history contained in an automated system of the pharmacy 152. Date and Time 354, 356, 358 are the dates and times when the refill response 114A, 114B, and new prescription 116, respectively, are sent.

New Prescriber Order Number 350 may be similar to the Prescriber Order Number 320, which may be used by the prescriber 154 to exactly match the refill request 112 to the patient and medication entry in an automated system of the prescriber 154. In embodiments, New Prescriber Order Number 350 is optional. In embodiments, New Prescriber Order Number 350 may be Prescriber Order Number 320.

The quality engine 150 may be configured to determine which messages are an interaction between the pharmacy 152 and the prescriber 154. An interaction is one or more messages between the pharmacy 152 and the prescriber 154. A common interaction is a refill request 112 from the pharmacy 152 with a matching refill response 154 from the prescriber 154. Often, the interaction will include at least one message from the pharmacy 152 and at least one message from the prescriber 154; however, the quality engine 150 may determine that one or more messages from only either the pharmacy 152 or the prescriber 154 is an interaction. For example, a refill request 112 may be an interaction as well as a refill response 114A, 114B without a matching refill request 112, although these interactions indicate there is likely a quality control problem.

The following are examples of interactions determined by some embodiments of the quality engine 150. A refill request 112 and refill response 114A. A refill request 112 and refill response 114B. A refill request 112, a refill response 114B, and a new prescription 116. Additionally, the quality engine 150 may include the original prescription 310 as part of the interaction.

In some embodiments, the quality engine 150 is configured to determine an interaction between the pharmacy 152 and the prescriber 154 based on one or more fields of the messages.

For example, the quality engine 150 of FIG. 2, determines that all messages from the interactions database 110 with the same Sender Message ID 330 are an interaction. The quality engine 150 may only examine messages in the interaction database 110 over a specific time and/or date range, or only messages that are from a particular pharmacy 152, and/or a particular prescriber 154, and/or only messages that were generated by particular technology venders of pharmacy 152, and/or only messages that were generated by particular technology vendors of prescribers.

In some embodiments, the quality engine 150 of FIG. 2 may select a refill request 112 from the database of interactions 110 based on a report that will be generated in step 430. The quality engine 150 will then determine the interaction associated with the refill request 112. In embodiments, the quality engine 150 will retrieve from the interactions database 110, refill responses 114A, 114B, and new prescriptions 116 that include a Sender Message ID 330 that matches a Sender Message ID 330 extracted from the refill request 112.

In embodiments, the quality engine 150 will search the interactions database 110 for messages that match the Sender Message ID 330 in the refill request 112. The quality engine 150 may restrict the search to a number of days after the Date and Time 352 of the refill request 112. For example, the quality engine 150 may restrict the search to seven days or thirty days after the refill request 112 was sent.

In embodiments, the quality engine 150 includes in the interaction all the messages found in the interaction database 110 that where the Relates to Sender Message ID 390, 392, 394 is equal to the Sender Message ID 330 extracted from the refill request 112. In embodiments, the quality engine 150 may determine the interaction differently. For example, the quality engine 150 may sort all the messages in a certain time frame with the Sender Message ID 330 being the key used to sort. Additionally, as another example, the quality engine 150 may retrieve any message from the interactions database 110 and then retrieve all other messages from the interactions database 110 where the Relates to Sender Message ID 390, 392, 394 matches the Sender Message ID 330 of the retrieved message.

The following are examples of interactions determined by some embodiments of the quality engine 150. A refill request 112 and refill response 114A. A refill request 112 and refill response 114B. A refill request 112, a refill response 114B, and a new prescription 116. Additionally, the quality engine 150 may include the original prescription 310 in the interaction.

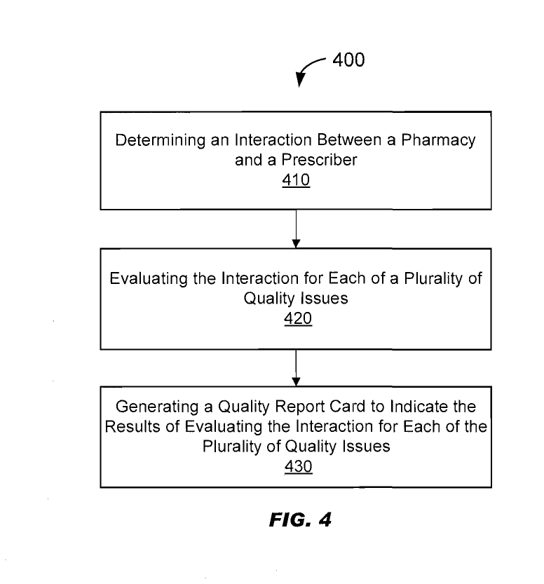

FIG. 4 illustrates an example of a method of the quality control system 100. The method 400 begins with step 410 of determining an interaction between a pharmacy and a prescriber.

For example, the quality engine 150 as described in relation to FIG. 3 may determine that the interaction is a refill request 112 sent by a pharmacy 152 and a refill response 114A sent by a prescriber 154.

In embodiments, the interactions of the messages may have already been determined prior to the quality engine 150 examining the messages of the interaction database 110.

The method 400 continues with step 420 of evaluating the interaction for each of a plurality of quality issues.

The following are examples of evaluating the interaction for each of a plurality of quality issues.

In embodiments, step 420 may include evaluating the refill request 112 (see FIG. 3) for each of a plurality of quality issues. For example, referring to FIG. 2, the quality engine 150 matches the refill request 112 to a drug product in the reference sources 140. The quality issue 120 is whether or not the refill request 112 matches a drug product.

In embodiments, step 420 may include evaluating whether or not the refill response 114A, 114B, meets a quality standard one or more of a plurality of quality issues. For example, in some embodiments, the quality engine 150 evaluates whether the refill response 114B is of type “D” denied, and if the refill response 114B is of type “D”, then the quality engine 150 checks whether the refill response 114B echoes back all the fields of the refill request 112, except for a denial reason code. The quality issue 120 is whether or not the refill request 112 echoes back all the fields of the refill request 112 except for a denial reason code, and the quality standard 130 may be that the refill request 112 must echo back all the fields of the refill request 112 except for a denial reason code or the refill response 114B fails the quality standard for that quality issue.

In embodiments, step 420 may include evaluating the new prescription 116 for each of a plurality of quality issues. In embodiments, step 420 may include evaluating whether or not the new prescription 116 meets a quality standard for each of a plurality of quality issues. For example, in some embodiments, the quality engine 150 evaluates whether the new prescription 116 echoes back the same Sender Message ID 330 that was sent in the refill request 112 message in the Relates to Sender Message ID 394. The quality issue 120 is whether or not the new prescription 116 sent after a Refill Response 114B request denied echoes back the same Sender Message ID 330 that was sent in the refill request 112 message, and the quality standard 130 may be that the new prescription 116 must echo back the same Sender Message ID 330 that was sent in the refill request 112 in the Relates to Sender Message ID 394.

In embodiments, step 420 may include evaluating whether or not the interaction includes both a refill request 112 and a corresponding refill response 114A, 114B. The quality issue 120 is whether or not the interaction includes a refill request 112 and a corresponding refill response 114A, 114B. In embodiments, the quality engine 150 may evaluate whether or not the quality standard 130 that the interaction must include both a refill request 112 and a refill response 114A, 114B is met.

The method 400 of FIG. 4 continues with step 430 of generating a quality report card 160 to indicate the results of evaluating the interaction for each of the plurality of quality issues.

For example, referring to FIG. 2, the quality engine 150 generates a quality report card 160 that indicates the result of evaluating the interaction for each of the plurality of quality issues 120. Continuing with the example above, the quality engine 150 generates a quality report card 160 indicating whether or not the refill request 112 matches a drug product, whether the refill response 112 echoes back all the fields of the refill request 112 except for a denial reason code, whether the new prescription 116 echoes back the same Sender Message ID 330 that was sent in the refill request 112 message, and whether or not the interaction includes both a refill request 112 and a corresponding refill response 114A, 114B.

In embodiments, the quality engine 150 generates a quality report card 160 that also indicates whether or not each of a plurality of quality standards was met. For example, the quality engine 150 may indicate whether or not the refill request 112 meets the quality standard 130 that the refill request 112 must match a drug product.

In embodiments, the quality engine 150 may be configured to generate a report for messages in the interaction database 110 sent and/or received during a specific time and/or date range, and/or for messages that are from a particular pharmacy 152, and/or prescribers 154, and/or for messages that were generated by particular technology venders of pharmacy 152, and/or messages that were generated by a particular technology venders of prescribers 154.

Thus, the method 400 of FIG. 4 provides for generating a quality report card for quality issues for interactions between a pharmacy and a prescriber.

FIG. 5 illustrates an example of a refill request. The refill request 112 may include a number of data fields 512 which may be named and may have values for the data fields 514. For example, illustrated in FIG. 5 is field “Date and Time” 512.1 which has a value of data and time sent 514.1. The field “Date and Time” 512.1 may be the date and time when the refill request 112 is sent.

The field “Sender Message ID” 512.2 has a value of unique message ID 514.2. The field “Sender Message ID” 512.2 may be a message identification that may be generated by the pharmacy to identify the refill request 112.

The field “Prescriber Order Number” 512.3 has a value of order number of prescriber 514.3. The field “Prescriber Order Number” 512.2 may be used by the prescriber to exactly match the refill request 112 to the patient and medication entry in an automated system of the prescriber. The field “Prescriber Order Number” 512.2 may be generated by the automated system of the prescriber and then included in a message to the pharmacy so that the pharmacy can echo back the “Prescriber Order Number” 512.2 for the prescriber to use for matching the Refill Request 112 to the, for example, the patient. The pharmacy 152 may receive the original prescription 310 as a fax or piece of paper so that the original prescription 310 may not include the Prescriber Order Number 320 in which case the pharmacy 152 does not include the Prescriber Order Number in the refill request 112.

The field “RX Reference Number” 512.4 has a value of number of RX reference 514.4. The field “RX Reference Number” 512.4 may be used by the pharmacy to locate the patient and medication history in an automated system of the pharmacy. The field “RX Reference Number” 512.4 may be generated by the automated system of the pharmacy and then included in a message to the prescriber so that the prescriber can echo back the “RX Reference Number” 512.4 for the pharmacy to use for matching the response to, for example, the patient and/or the Refill Request 112.

The field “Prescription” 512.5 has a value of “Amoxicillin 500 mg oral capsule” 514.5. The field prescription 512.5 may be a free text field where a prescriber such as a doctor has written or typed in a prescription. The field “Strength” 512.6 has a value of “500” 514.6. The field “Strength Qualifier” 512.7 has a value of “mg” 514.7. The field “Dosage Form” 512.8 has a value of “Oral Capsule” 514.8. In embodiments, the fields “Strength” 512.6, “Strength Qualifier” 512.7, and “Dosage Form” are optional fields. The field “Quantity” 512.9 has a value of “100” 514.9. The “Quantity” 512.9 may be the quantity of “oral capsule” for the prescription in this case “500 mg oral capsule.” The field “Quantity Qualifier” 512.10 has a value of “mg” 514.10. The field “Generic Substitution Permitted” 512.11 has a value “No” 514.11. The “Generic Substitution Permitted” may be a required field that indicates whether or not a generic may be substituted for a brand named prescription. The field “Direction Field” 512.12 has a value “Take 1 every four hours” 514.12. The “Direction Field” 512.12 may be a field that indicates what directions should be printed on the label of the prescription for the patient to follow. The field “Pharmacy Notes” 512.13 may be an optional field that provides the pharmacy with notes for fulfilling the prescription. The field “Pharmacy” 512.14 may include information that identifies a pharmacy. The field “Prescriber” 512.15 may be information that identifies a prescriber. The field “Gender” 512.16 may be an optional field that includes the gender of the patient. The field “Age” 512.17 may be an optional field that includes information indicating the age of the patient. The field “Patient” 512.18 may include information that can be used to identify the patient. The field “ID Number” 512.19 may have a value of number 514.19. The “ID Number” 512.19 may be a number that identifies the drug product intended to be used to fulfill the prescription such as a National Drug Code (NDC) System number.

The field “Last Filed Date” 512.21 may have a value of date when last filed 514.21. The “Last Filled Date” 512.21 is supposed to be filled with the date when the prescription was last filled at the pharmacy. The field “Last Filled Date” 512.21 may be the date of the last time the filled of the original prescription 116 that the refill request 112 is requesting a refill of. The field “Date Written” 512.22 may have a value of date of original prescription. The field “Date Written” 512.22 may be the date of the original prescription 116 that the refill request 112 is requesting a refill of.

When the values of some fields are entered they may be selected from a limited number of options. For example, field 512.16 “Gender” may have only three possible selections of “Male”, “Female”, or “Uncertain.” Other fields may be entered free hand. Moreover, the quality engine 150 may access information in the reference sources 140 based on values of some of the fields. For example, the quality engine 150 may verify that the Prescriber 512.15 is a registered prescriber 512.15 in a database of prescribers that may be included in the references sources 140. Some fields may be optional. For example, the “Strength” 512.6 field may be an optional field which may or may not be included in a refill request 112. Some fields may provide information, which is included in other fields. For example as illustrated, “500” 514.6 is redundant to “Amoxicillin 500 mg oral capsule” 514.5.

In embodiments, the refill request 112 may not be organized together, but may be grouped separately.

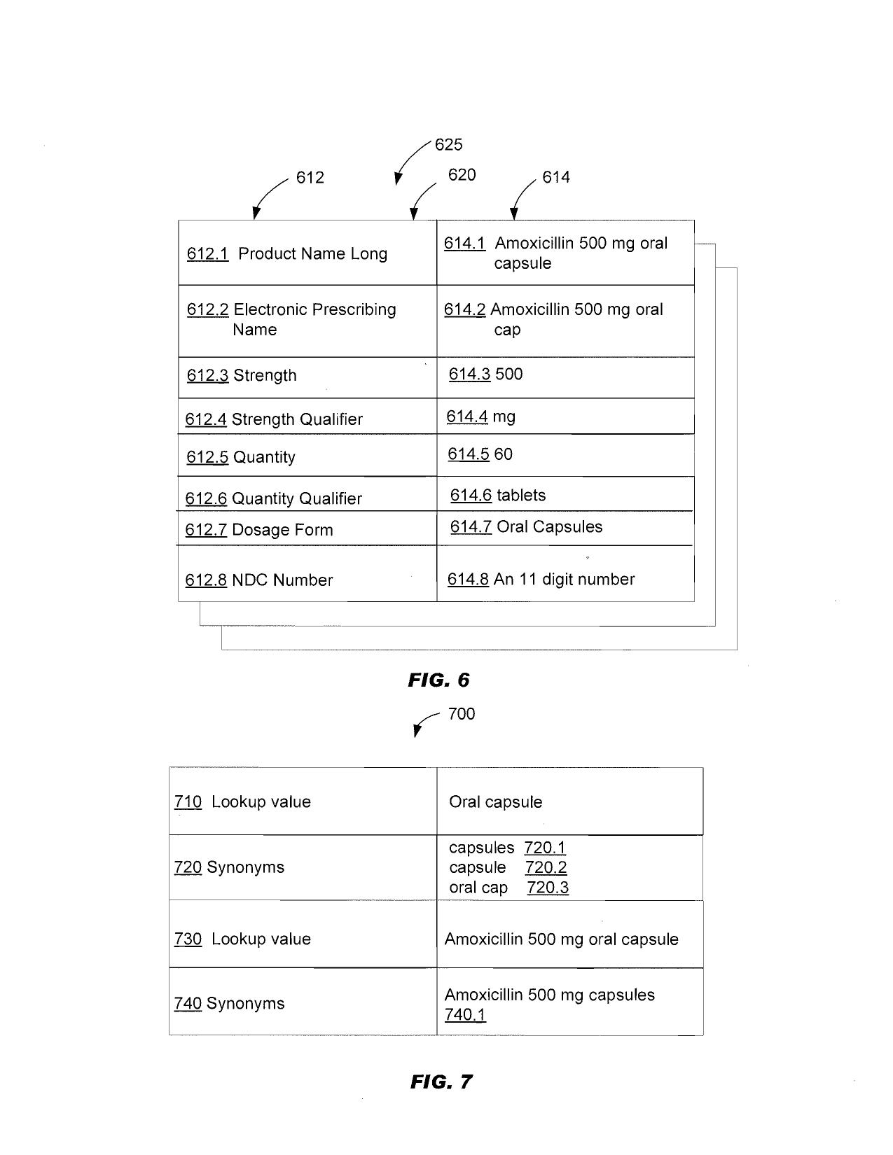

FIG. 6 illustrates an example of a database of drug products. The references sources 140 (see FIG. 2) may include a database of drug products 625, which is a plurality of drug products 620 that may be organized to facilitate retrieval and storage. The database of drug products 625 may be a database provided by a third party supplier of information regarding drug products 620. Each of the drug products 620 may be a collection of data or fields. Each of the drug products 620 may be a description of a drug product that may be identified by a National Drug Code (NDC) System number. Each of the drug products 620 may include the following fields. A product name long field 612.1 may be a field that includes a full description of the prescription, “Amoxicillin 500 mg oral capsule” 614.1. An electronic prescribing name 612.2 may be a description of the drug product 620 that may be used in an electronic prescription, “Amoxicillin 500 mg oral cap” 612.2. A strength 612.3 may be a strength of the drug product 620. A quantity qualifier 612.6 may be a qualifier for the strength 612.3 of the drug product 620. A dosage form 612.7 may be a dosage form for the drug product 620. NDC number 612.8 may be a NDC number for the drug product. The NDC number may be a unique number that identifies the drug product.

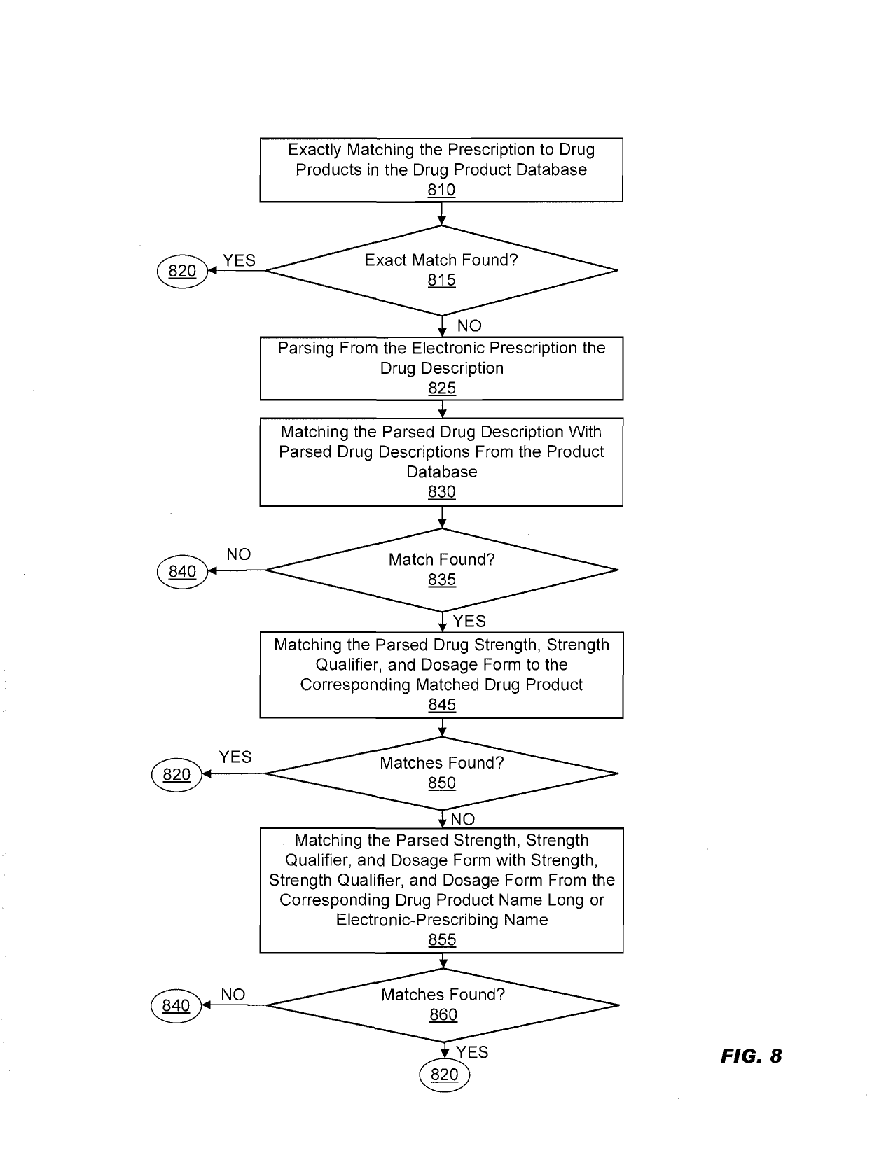

FIG. 7 illustrates an example of a synonym database. A synonym includes a lookup value 710, which is “oral capsule,” and synonyms 720. As illustrated there are three synonyms for “oral capsule” 710: “capsules” 720.1, “capsule” 720.2, and “oral cap” 720.3. Synonyms may be added to the synonym database by qualified people. The synonym database may be used by the quality engine 150 when exact matches are not found for a value such as “oral capsule.” To find acceptable synonyms that may match “oral capsule” the quality engine 150 looks up “oral capsule” in the synonym database and then may use the synonyms found in the synonym database for “oral capsule” such as “oral cap” as a match for “oral capsules.” Also illustrated is a synonym for “Amoxicillin 500 mg oral capsule” 730, which illustrates that phrases may have synonyms, “Amoxicillin 500 mg capsules” 740.1.

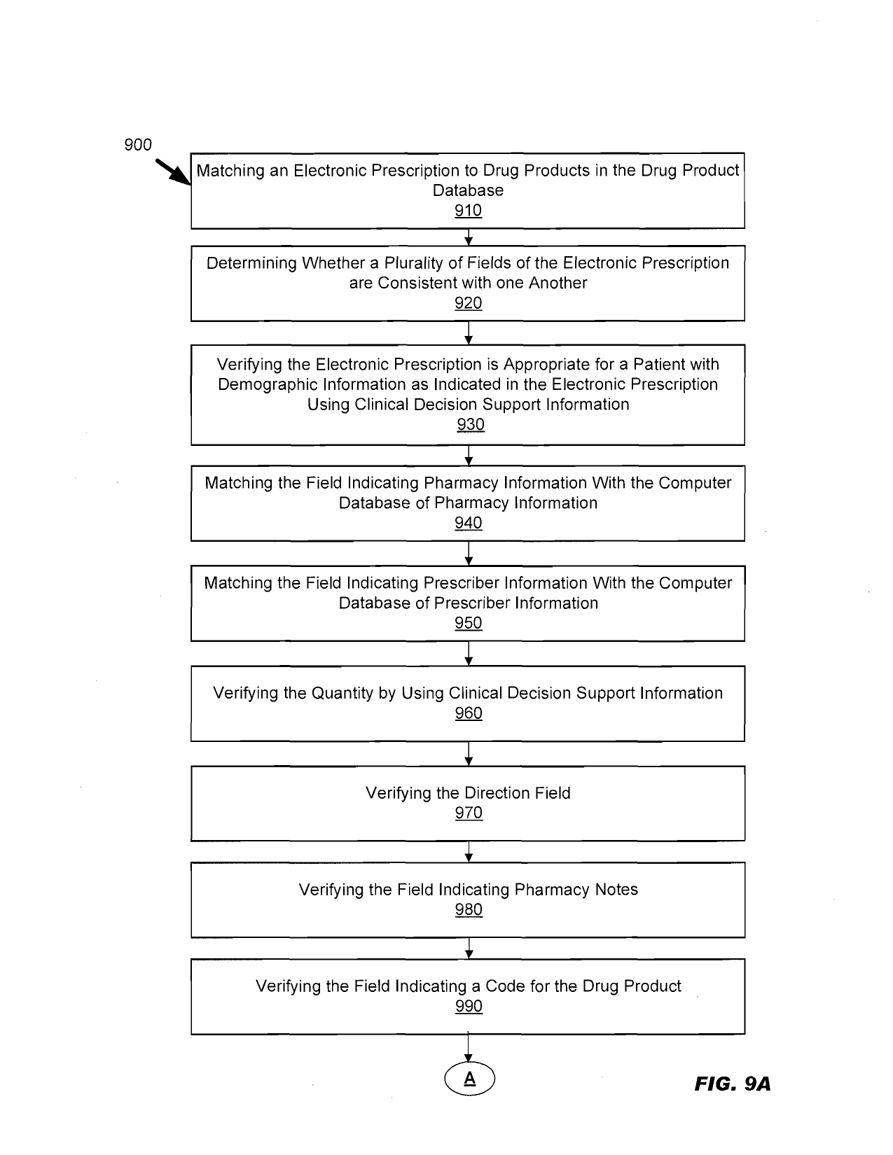

FIG. 8 illustrates an example of a method to match a prescription with a drug product in a drug product database in the reference sources 140 (see FIG. 2). The method may be carried out by the quality engine 150 (see FIG. 2.) The quality engine 150 is attempting to determine whether or not the prescription 512.5, which may be part of the refill request 112, or the new prescription 116, matches a drug product 620 (see FIG. 6) in a database of drug products 625 in the reference sources 140. Because the prescription 512.5 may have been written out by hand or typed in and may not be in a precise form, the quality engine 150 may not be able to directly match the prescription 512.5 to a drug product 620, and may attempt to perform matches that are not exact matches.

The method begins with step 810 of exactly matching the prescription to drug products in the drug product database. The quality engine (see FIG. 2) may attempt to exactly match the prescription 512.5 (see FIG. 5) to a database of drug products 625 (FIG. 6) in the reference sources 140 (see FIG. 2). The database of drug products 625 may include hundreds or thousands of drug products 620. Additionally, there may be more than one database of drug products 625 so that when the quality engine 150 is described as searching a database of drug products 625, the quality engine 150 may search more than one database of drug products 625, although only a single search may be described.

An example of step 810 is the quality engine 150 attempting to match the prescription 512.5 (FIG. 5), “Amoxicillin 500 mg oral capsule”, to the product name long 612.1, “Amoxicillin 500 mg oral capsule” 614.1 in the database of drug products 625. In this case there is an exact match, so the quality engine 150 may determine that since the two fields matched exactly that the prescription 512.5 matches the drug product 620.

If there had not been an exact match between the prescription 512.5 and the product name long 612.1, then the quality engine 150 may attempt to match the prescription 512.5 with the electronic prescribing name 612.2. For example, if the electronic prescription 512.5 had been “Amoxicillin 500 mg oral cap” (“capsule” has been changed to “cap”) then the quality engine 150 would match the electronic prescription 512.5 to the electronic prescribing name 612.2 (“Amoxicillin 500 mg oral cap”), and an exact match would be found to the electronic prescribing name 612.2. The quality engine 150 may determine that since the prescription 512.5 and the electronic prescribing name 612.2 exactly matched, that the prescription 512.5 matched the drug product 620.

When attempting to match two fields, the quality engine may take out all or some of the spaces in the prescription 512.5 and/or fields of the drug product 620. Additionally, the quality engine 150 may ignore capitalization. Moreover, the quality engine 150 may look for minor spelling errors. In embodiments, where the database of drug products is represented in a relationship database, the quality engine may form structured queries using a structured query language and submit the structured queries to a database engine to check for a match. Moreover, if an exact match is not found between the prescription 512.5 and the database of drug products 625, then the quality engine 150 may use the synonym database 700 to check for a match. For example, if prescription 512.5 were “Amoxicillin 500 mg capsules” and the product name long 612.1 were “Amoxicillin 500 mg oral capsule” 614.1, then there would not be an exact match. The quality engine 150 may look up “Amoxicillin 500 mg oral capsule” in the synonym data 700 and find a match with a synonym 740.1 of “Amoxicillin 500 mg capsules.” Since a synonym of the product name long 614.1 matches the prescription 512.5 the quality engine 150 may determine this to be a match.

The method proceeds with step 815 of exact match found. If an exact match is found, then the method ends 820 with the quality engine returning an indication that a drug product 620 in the drug product database matched the prescription 512.5 and the method may return which of the drug products 620 matched the prescription 512.5. If an exact match was found with the synonym database, then the quality engine may return an indication that a drug product 620 in the drug product database matched the prescription 512.5, and the quality engine may return that the entry “Amoxicillin 500 mg oral capsule” 614.1 in the database of drug products 620 was matched to the refill request 112 through the synonym database with “Amoxicillin 500 mg capsules.”

If no exact match was found, the method continues with step 825 of parsing from the prescription the drug description. For example, if the prescription 512.5 were “amoxicillin 500 mg oral capsule” 514.5, then the quality engine 150 would parse “amoxicillin” from the prescription 512.5. The quality engine 150 may parse the drug description from the prescription 512.5 by locating the first numeric character in the text string from the left. And, if a valid strength qualifier unit follows the numeric character, then assume the first number character is the strength. So, for example, in the string “amoxicillin 500 mg oral capsule,” the string would be scanned from the left until reaching “500.” Then the quality engine 150 would scan “mg” and determine that since “mg” is a valid strength qualifier that “500” is the strength and “amoxicillin” is the drug description. The characters to the left of “mg”, which are “oral capsule”, may be determined to be the dosage form.

In embodiments, the NLP engine 155 may be used by the quality engine 150 to determine the dosage form in different ways. For example, the NLP engine 155 may build a parse tree to determine the dosage form, and/or may compare the words in the prescription with known dosage forms to determine the dosage form. In each of the steps of the methods described, the quality engine 150 may use the NLP engine 155 to determine fields in different ways that utilize natural language processing techniques to determine the intended value of fields. The examples used to describe some embodiments of the quality engine 150 are meant to be non-limiting. The quality engine 150 may in each step use different methods to determine fields from the strings.

The method continues with step 830 of matching the parsed drug description with drug descriptions from the product database. The quality engine 150 matches the parsed drug description, “amoxicillin” in this case to the drug descriptions of the database of drug products 625. Each of the drug products 620 in the database of drug products 625 may need to be parsed in a similar fashion as the prescription 514.5 to create drug descriptions for matching. The quality engine 150 may also attempt to match the drug description with the synonym database which may contain synonyms for drug descriptions in the drug product database.

The method continues with step 835 of match found. If a match between the parsed drug description from the prescription was not found then the method may terminate with no match between the prescription 512.5 and the database of drug products 625.

If a match between the parsed drug description from the prescription 512.5 was found, then the method may continue with step 645 of matching the parsed drug strength, strength qualifier, and dosage form to the corresponding matched drug product. Continuing with the example above, for the prescription 512.5 with a value of “amoxicillin 500 mg oral capsule” 514.5, the parsed strength is “500,” the parsed strength qualifier is “mg,” the parsed dosage form is “oral capsule.” So, the parsed strength “500” would match 614.3 “500”; the parsed strength qualifier “mg” would match 614.4 “mg”; and, the parsed dosage form “oral capsule” would match 614.5 “oral capsule.” So, since the prescription 512.1 was able to be parsed and then matched to a drug product 620, the quality engine 150 determines that the prescription 512.5 matches this drug product 620.

If a match failed between the parsed strength, strength qualifier, or dosage and the corresponding matched drug product, then the quality engine 150 may attempt to match each of the parsed fields with the synonym database and then attempt to match each of the synonyms with the corresponding matched drug product.

The method continues with step 850 of matches found. If the parsed strength, strength qualifier, and dosage matched the corresponding matched drug product either directly or through the synonym database, then the method ends with step 820 indicating that a match was found and the particulars of how the match was found.

If the parsed strength, strength qualifier, and dosage did not match the corresponding matched drug product, then the method may continue with step 855 of matching the parsed strength, strength qualifier, and dosage form with strength, strength qualifier, and dosage form from the corresponding drug product name long or electronic-prescribing name.

In the example above, the prescription 512.5 has a value of “amoxicillin 500 mg oral capsule” 514.5. The parsed values are strength: “500,” strength qualifier: “mg”, and dosage form: “oral capsule.” The corresponding fields would be parsed from the drug product 620 field that matched the drug name “amoxicillin.” So, “amoxicillin 500 mg oral capsule” 614.1 from the database of drug products 620 would be parsed. Since all the fields match, the quality engine 150 may determine that there is a match. Additionally, if a match failed between the fields in 514.5 and the parsed strength, strength qualifier, and dosage, then a match would be tested between the field 614.2, since it also has “amoxicillin”. Moreover, the quality engine 150 may use the synonym database to see if there is not a direct match that a synonym may match. For example, if the electronic prescription has a value of “amoxicillin 500 mg oral cap,” then the dosage form “oral cap” would not match 614.1 “oral capsule.” But, the quality engine 150 may look up “oral capsule” in the synonym database 700 and determine that “oral cap” is a synonym for “oral capsule” and count “oral cap” as a match to “oral capsule.”

The method continues with step 860 of match found. If a match was found between the parsed fields and the corresponding matched drug product, then the method terminates with step 820 of indicating that a match was found and may indicate how the match was found. If a match was not found, then the method terminates with step 840 of an indication that no match was found. Each of the steps illustrated in FIG. 8 may be optional and the steps may be carried out in a different order.

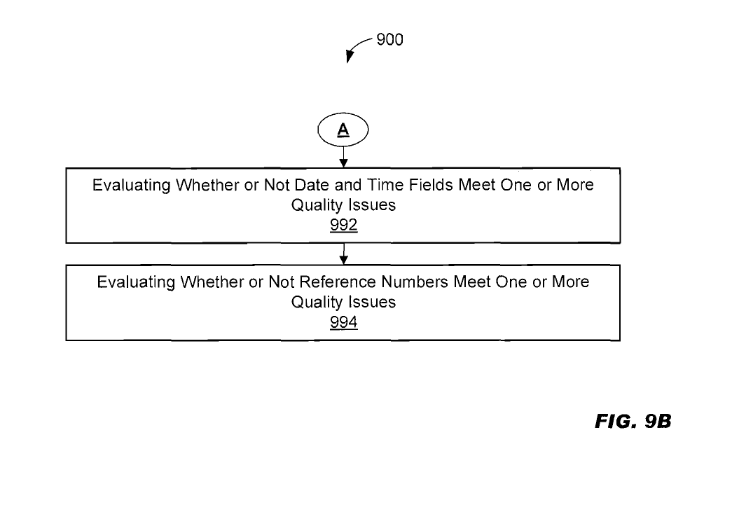

FIGS. 9A and 9B illustrates an example of a method 900 for evaluating a refill request for each of a plurality of quality issues and generating a quality report card to indicate the results of evaluating a refill request for each of a plurality of quality issues.

The method begins with step 910 of matching a prescription to drug products in the drug product database. The first quality issue may be whether or not the prescription 512.5 matches a drug product 620 in the database of drug products 625. The method discussed in relation to FIG. 8 could be used for evaluating whether or not the prescription 512.5 matches a drug product 620 in the database of drug products 625. The result of the matching may be indicated on a quality report card for the refill request 112.

The method continues with step 920 of determining whether a plurality of fields of the refill request 112 is consistent with one another. The second quality issue may be whether a plurality of fields of the refill request 112 are consistent with one another. The following are examples of testing whether or not the plurality of fields is consistent with one another. The prescription 512.5 of the refill request 112 (see FIG. 5) contains a drug name, strength, strength qualifier, and dosage form. Parsing the prescription 512.5 to get these individual fields is discussed above. The refill request 112 also may contain fields where the strength 512.2, strength qualifier 512.3, and dosage form 512.4 are optionally included as separate fields. As an example, in the refill request 112 that is illustrated in FIG. 5, the parsed drug name is “amoxicillin”, the parsed strength is “500”, the parsed strength qualifier is “mg,” and the parsed dosage form is “oral capsule.” These parsed values may be tested with additional fields strength 512.6, strength qualifier 512.7, and dosage form 512.8 to insure they are consistent with one another. In the example of FIG. 5, parsed strength “500” is equal to “500” 514.6, parsed strength qualifier “mg” is equal to “mg” 514.7, and parsed dosage form “oral capsule” is equal to “Oral capsule” 514.8. Moreover, a generic substitution permitted 512.11 may be tested to insure it is consistent with the matched drug product. For example, if the generic substitution permitted 512.11 has a value of “no” 514.11, then the matched drug product 620 would be checked to insure the matched drug product 620 is not a generic. The quality report card may be marked to indicate the results of evaluating whether the plurality of fields is consistent with one another.

The method may continue with step 930 of verifying the electronic prescription is appropriate for a patient with demographic information as indicated in the refill request using decision support information. The third quality issue may be whether or not the electronic prescription is appropriate for a patient with demographic information as indicated in the electronic prescription. For example, patient demographic information may be included in the refill request 112. In FIG. 5 the gender 512.16 has a value of “Female” 514.16, and age 512.17 has a value of “27 years” 514.17. Decision support information contained in the reference sources 140 can be accessed to determine whether or not the refill request 112 is appropriate for a patient with this demographic information. The quality report card may be marked to indicate the results of evaluating whether or not the electronic prescription is appropriate for the patient's demographic information. In embodiments, the method may include looking up demographic information for the patient in a patient database and using that information to insure that the refill request 112 is appropriate.

The method may continue with step 940 of matching the field indicating pharmacy information with the computer database of pharmacy information. The fourth quality issue may be whether or not the pharmacy information 514.14 in the refill request 112 matches a database of pharmacy information. The refill request 112 may include information of which pharmacy 512.14 or fulfillment center to forward the refill request 112. The quality report card may be marked to indicate the results of evaluating whether or not the pharmacy information 514.14 matches a database of pharmacy information. In embodiments, partial matches may meet the quality standard. For example, minor differences such as a slightly incorrect street address may meet the quality standard.

The method may continue with step 750 of matching the field indicating prescriber information with the computer database of prescriber information. The fifth quality issue may be whether or not the prescriber information 514.15 in the refill request 112 matches a database of prescriber information. The electronic prescription 110 may include information of which prescriber 512.15, for example a doctor, the original prescription 116 came from. The quality report card may be marked to indicate the results of evaluating whether or not the prescriber information 514.15 matches a database of prescriber information in the reference sources 140.

The method may continue with step 960 of verifying the quantity by using clinical decision support information. The sixth quality issue may be whether or not the quantity 512.9 in the refill request 112 is appropriate. The refill request 112 may include information of a quantity 512.5. The decision support information may include information for appropriate quantities of drug products. The decision support information may include regulations for controlled substances that limit the quantity 312.5 of a control substance that can be prescribed. The quality engine 150 may use information in the decision support information to determine whether or not the quantity 312.5 is appropriate or not. The report card may be marked to indicate whether or not the quantity 310.5 is appropriate by using decision support information.

The method may continue with step 970 of verifying the dosage by using clinical decision support information. The seventh quality standard may be whether or not the dosage in the electronic prescription is appropriate. The refill request 112 may include information of a dosage in a direction field 510.12. The quality engine 150 can calculate the dosage by parsing the direction field 510.12 and the matched drug product 620. For example, “take one every four hours” 514.12, and the drug product 620 is 500 mg of amoxicillin. The quality engine 150 can then look in the clinical decision support information to see if this dosage is appropriate in general and can check if this dosage is appropriate for the demographic information of the patient. The quality report card may be marked to indicate the results of evaluating whether or not the dosage is appropriate. The quality standard may be whether or not the dosage is appropriate or not according to the decision support information.

The method may continue with step 980 of verifying the field indicating directions. The eighth quality issue may be whether or not the field indicating directions 512.12 in the refill request 112 is appropriate. The refill request 112 may include directions such as “Take 1 every four hours” 514.12. The quality engine 150 may parse the directions 514.12 to ensure that the directions are a simple understandable sentence. For example, the quality engine 150 may use natural language processing, for example NLP Engine 155, to separate out the subject, verb, and object as well as nouns and qualifiers. The quality engine 150 may then match the parsed directions 514.12 against a list of common directions to determine whether or not the directions 514.12 are appropriate. For example, “take” is a verb, and “1 every four hours” is an adverbial phrase. The object of the verb is missing and would be implied to be “one oral capsule”, although the fact that the object of the verb is not explicit may raise a quality issue. The quality engine 150 may also search all the words in the directions 514.12 to insure that a Latin word has not been used. The eight quality standard may be that the field indicating directions 512.12 must be appropriate. The quality report card may be marked to indicate the results of evaluating whether or not the directions 512.12 are appropriate.

The method may continue with verifying the field indicating pharmacy notes 980. The ninth quality issue may be whether or not the pharmacy notes 510.13 in the refill request 112 are appropriate. The refill request 112 may include pharmacy notes 512.13. The quality engine 150 may parse the pharmacy notes 512.13 to insure that the pharmacy notes 512.13 are appropriate. For example, the quality engine 150 may check to insure that the pharmacy notes 512.13 contain only additional prescriber instructions to the pharmacy and not notes intended for the patient. The quality engine 150 may use clinical support information to insure the pharmacy notes are appropriate. The report card may be marked to indicate the results of evaluating whether or not the pharmacy notes are appropriate.

The method may continue with step 990 of verifying the field indicating a code for the drug product. For example, the code may be a national drug code (NDC) number. The tenth quality issue may be whether or not a code for the drug product 620 is verified. As an example, an ID number 512.19 may be included with the refill request 112 and this number 512.19 may be tested to insure that it matches the NDC number 612.6 of the matched drug product 620. The quality report card may be marked to indicate the results of evaluating whether or not the field indicating a code for the drug product is verified.

The method may continue with step 992 of evaluating whether or not date and time fields meet one or more quality issues. For example, the quality engine 150 may evaluate whether the “last filled date” 512.21, which should be the last time the original prescription 116 was filled at the pharmacy 152, is less than 2 days from the date of the “Date and Time” 512.1 of the refill request 112. The quality report card may be marked to indicate the results of evaluating whether or not the “last filled date” 512.21 was filled at the pharmacy 152 less than 2 days from the date of the “Date and Time” 512.1. The quality engine 150 may indicate on the quality report card that the quality issue should be referred to an expert review if the “last filled date” 512.21 was filled at the pharmacy 152 less than 2 days from the date of the “Date and Time” 512.1.

Additionally, the quality engine 150 may evaluate whether the “date written” 512.212, which should be the date written of the original prescription 116, is less than 2 days from the date of the “Date and Time” 512.1 of the refill request 112. The quality report card may be marked to indicate the results of evaluating whether the “date written” 512.212 is less than 2 days from the date of the “Date and Time” 512.1 of the refill request 112. The quality engine 150 may indicate on the quality report card that the quality issue should be referred to an expert review if the “date written” 512.21 was is less than 2 days from the date of the “Date and Time” 512.1.

The method may continue with step 994 of evaluating whether or not reference numbers meet one or more quality issues. For example, the quality engine 150 may evaluate whether or not the refill request 112 includes a “Prescriber Order Number” 512.3, and whether or not the “Prescriber Order Number” 512.3 is the same “Prescriber Order Number” 512.3 that was included in the original prescription 116. The quality engine 150 may indicate the results of evaluating whether or not the refill request 112 includes a “Prescriber Order Number” 512.3 and whether or not the “Prescriber Order Number” 512.3 is the same number included in the original prescription 116.

Additionally, the quality engine 150 may evaluate whether or not the refill request 112 includes an “RX Reference Number” 512.4. The quality engine 150 may indicate the results of evaluating whether or not the refill request 112 includes an “RX Reference Number” 512.4.

The method may then end. In the method of FIG. 9 each of the steps is optional and the steps may be performed in a different order.

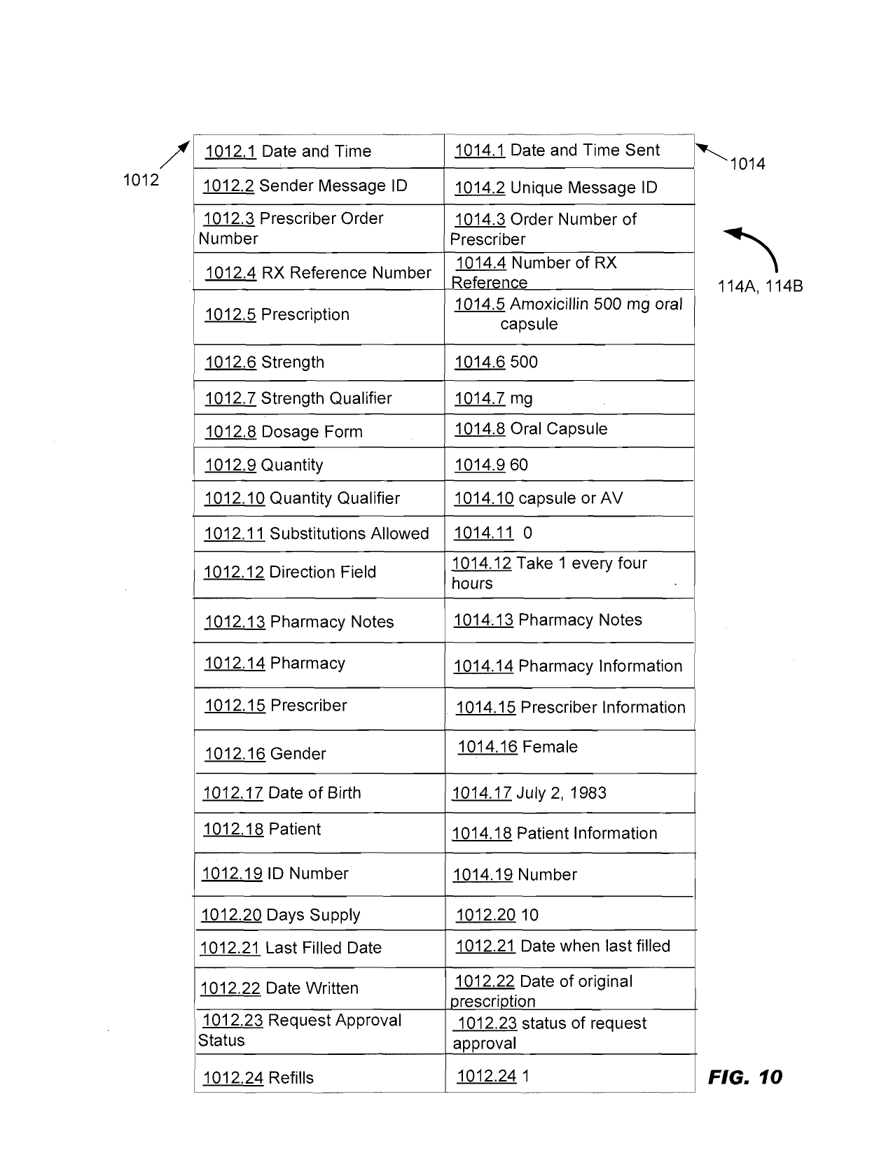

FIG. 10 illustrates an example of a refill response. The refill response 114A, 114B may include a number of data fields 1012 which may be named and may have values for the data fields 1014. For example, illustrated in FIG. 10 is field “Date and Time” 1012.1 which has a value of data and time sent 1014.1. The field “Date and Time” 1012.1 may be the date and time when the refill response 116 is sent.

The field “Sender Message ID” 1012.2 has a value of unique message ID 1014.2. The field “Sender Message ID” 1012.2 may be a message identification that may be generated by the pharmacy to identify the refill request 112.

The field “Prescriber Order Number” 1012.3 has a value of order number of prescriber 514.3. The field “Prescriber Order Number” 1012.2 may be used by the prescriber to exactly match the refill response 116 to the patient and medication entry in an automated system of the prescriber.

The field “RX Reference Number” 1012.4 has a value of number of RX reference 1014.4. The field “RX Reference Number” 512.4 may be used by the pharmacy to locate the patient and medication history in an automated system of the pharmacy.

The field “Prescription” 1012.5 has a value of “Amoxicillin 500 mg oral capsule” 1014.5. The field prescription 1012.5 may be a free text field where a prescriber such as a doctor has written or typed in a prescription. The field “Strength” 1012.6 has a value of “500” 1014.6. The field “Strength Qualifier” 1012.7 has a value of “mg” 1014.7. The field “Dosage Form” 1012.8 has a value of “Oral Capsule” 1014.8. The field “Quantity” 1012.9 has a value of “100” 1014.9. The “Quantity” 1012.9 may be the quantity of “oral capsule” for the prescription in this case “500 mg oral capsule.” The field “Quantity Qualifier” 1012.10 has a value of “mg” 1014.10. The field “Generic Substitution Permitted” 1012.11 has a value “No” 1014.11. The “Generic Substitution Permitted” may be an optional field that indicates whether or not a generic may be substituted for a brand name prescription. The field “Direction Field” 1012.12 has a value “Take 1 every four hours” 1014.12. The “Direction Field” 1012.12 may be a field that indicates what directions should be printed on the label of the prescription for the patient to follow. The field “Pharmacy Notes” 1012.13 may be an optional field that provides the pharmacy or pharmacy with notes for fulfilling the prescription. The field “Pharmacy” 1012.14 may include information that identifies a pharmacy or pharmacy. The field “Prescriber” 1012.15 may be information that identifies a prescriber. The field “Gender” 1012.16 may be an optional field that includes the gender of the patient. The field “Age” 1012.17 may be an optional field that includes information indicating the age of the patient. The field “Patient” 1012.18 may include information that can be used to identify the patient. The field “ID Number” 1012.19 may have a value of number 1014.19. The “ID Number” 1012.19 may be a number that identifies the drug product intended to be used to fulfill the prescription such as a National Drug Code (NDC) System number.

The field “Last Filed Date” 1012.21 may have a value of date when last filed 1014.21. The “Last Filled Date” 1012.21 is supposed to be filled with the date when the prescription was last filled at the pharmacy. The field “Last Filled Date” 1012.21 may be the date of the last time the filled of the original prescription 116 that the refill request 112 is requesting a refill of. The field “Date Written” 1012.22 may have a value of date of original prescription. The field “Date Written” 1012.22 may be the date of the original prescription 116 that the refill response 112 is responding to a request for a refill. The field “Request Approval Status” 1012.23 may have a value that indicates the request approval status 1012.23. For example, the “Request Approval Status” 1012.23 may have values of “A” for approved, “C” for approved with changes, “D” denied, and “N” denied with a new prescription to follow. The field “Refills” 1012.24 may have a value that indicates the number of refill “1” 1012.24. Field 1012.24 must be a positive whole number.

When the values of some fields are entered they may be selected from a limited number of options. For example, field 1012.16 “Gender” may have only three possible selections of “Male”, “Female”, or “Uncertain.” Other fields may be entered free hand. Moreover, the quality engine 150 may access information in the reference sources 140 based on values of some of the fields. For example, the quality engine 150 may verify that the Prescriber 1012.15 is a registered prescriber 1012.15 in a database of prescribers that may be included in the references sources 140. Some fields may be optional. For example, the “Strength” 1012.6 field may be an optional field which may or may not be included in a refill response 112. Some fields may provide information, which is included in other fields. For example as illustrated, “500” 1014.6 is redundant to “Amoxicillin 500 mg oral capsule” 1014.5.

In embodiments, the refill request 112 may not be organized together, but may be grouped separately.

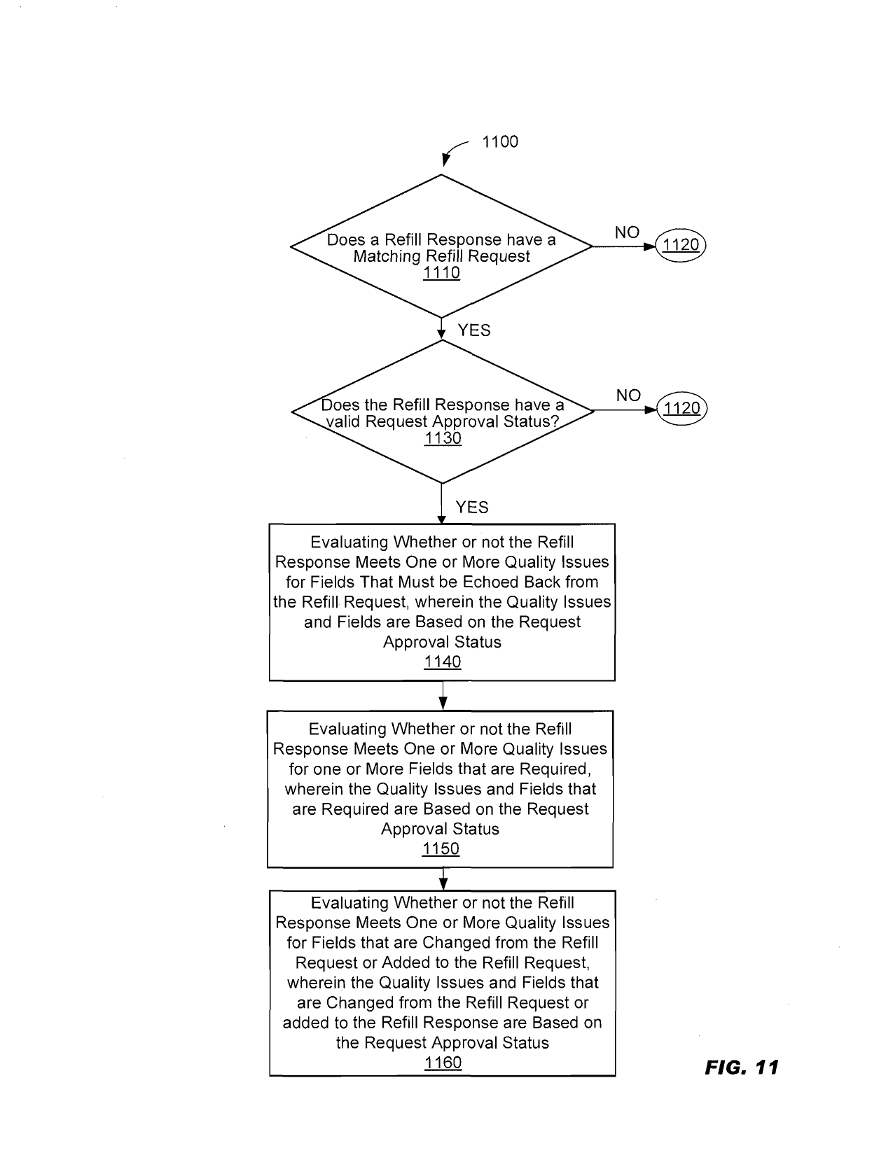

FIG. 11 illustrates an example of a method 1100 for evaluating a refill response for each of a plurality of quality issues and generating a quality report card to indicate the results of evaluating a refill request for each of a plurality of quality issues.

The method 1100 begins with step 1110 of does the refill response have a matching refill request. For example, the quality engine 150 may search the database of interactions 110 for a refill request 112 that has a “Sender Message ID” 512.2 that is the same as the “Sender Message ID” 1012.2 of the refill response 114A, 114B. The quality engine 150 may match the messages as an interaction. If there is no matching refill request 112 to the refill response, then the method may end at 1120. If there is a matching refill request 112 then the method may continue with 1130. The result of determining whether or not the refill response 114A, 114B has a matching refill request 112 may be indicated on a quality report card for the refill response 114A, 114B.

The method 1100 may continue with step 1130 of does the refill response have a valid request approval status. For example, the quality engine 150 may determine whether or not the “Request Approval Status” 1012.23 has a value of one of “A”, “C”, “D”, or “N” in field 1014.23. If the “Request Approval Status” does not have valid request approval status, then the method may end at 1120. If the “Request Approval Status” is a valid request approval status, then the method may continue with 1140. The result of determining whether or not the refill response 114A, 114B has a valid “Request Approval Status” may be indicated on a quality report card for the refill response 114A, 114B.

The method 1100 may continue with the following three steps which for convenience will be considered together. Step 1140 of evaluating whether or not the refill response meets one or more quality issues for fields that must be echoed back from the refill request, wherein the quality issues and fields that must be echoed back are based on the request approval status. Step 1150 of evaluating whether or not the refill response meets one or more quality issues for one or more fields that are required, wherein the quality issues and fields that are required are based on the request approval status. Step 1160 of evaluating whether or not the refill response meets one or more quality issues for fields that are changed from the refill request or added to the refill request, wherein the quality issues and fields that are changed from the refill request or added to the refill response are based on the request approval status.

For example, the quality engine 150 may determine the “Request Approval Status” 1012.23, and based on the value of the “Request Approval Status” perform step 1140 of evaluating whether or not the refill response meets one or more quality issues for fields that must be echoed back from the refill request, perform step 1150 of evaluating whether or not the refill response meets one or more quality issues for one or more fields that are required, and perform step 1160 of evaluating whether or not the refill response meets one or more quality issues for fields that are changed from the refill request or added to the refill request.

The following example, illustrates an embodiment where there are four values, “A”, “C”, “D”, and “N” for “Request Approval Status.”

For a “Request Approval Status” 1012.23 of “A” for “approved”, the following are the quality issues and the different fields.

For the field “Date Written” 1012.22, the quality issues are whether or not the field “Date Written” 1012.22 is included with the refill response 116, and whether or not the “Date Written” 1012.22 is less than two days from the date of the prescriber generated REFRIES message. “Date Written” 1012.22 is a required field. The quality engine 150 performs step 1160 by determining whether or not “Date Written” 1012.22 is included in the refill response 116. The prescriber 154 can either add “Date Written” 1012.22 to the refill response 116, or change “Date Written” 1012.22 from the refill request 112, but the “Date Written” 1012.22 must be part of the refill response 116. The quality engine 150 also determines whether or not the date populated in the “Date Written” 12.22 is less than two days from the date of the prescriber generated a REFRES message. The quality engine 150 adds to the quality report card whether or not the “Date Written” 1012.22 field is included with the refill response 116, and whether or not the date populated in the “Date Written” 12.22 is less than two days from the date of the prescriber generated a REFRES message.

The prescriber 154 must include the required field “Substitutions Allowed” 1012.11, which is a required field from step 1150, in the refill response 114A. The prescriber 154 may change the substitution code to match with the intent of the prescription. In embodiments, the prescriber 154 can only send in the refill response 114A of a “0”, which means generic substitution permitted or a “1”, which means dispense as written. However, in the refill request 112 pharmacies 152 may send values from 0 to 8 (except 6). The prescriber 154 must convert any value other than 0 or 1 in the refill request 112 to a 0 or a 1 in the refill response 114A. When the prescriber 154 receives a code of “7”, which means substitution not allowed that a brand drug mandated by law, the prescriber 154 should populate the refill response with a 1, which means substitution code not allowed by prescriber. All other codes received in the refill request 112 should be converted to a 0. The quality engine 150 evaluates whether or not the rules described above are followed by the prescriber 154 by examining the “Substitutions Allowed” 1012.11 field in the refill response 114A and the “Substitutions Allowed” 512.11 field in the refill request 112.

The quality engine 150 indicates on the quality report card the result of the quality engine 150 evaluating whether or not the refill response 114A refill response 114A follows the rules described above in relation to the field “Substitutions Allowed” 1012.11.

The quality engine 150 evaluates whether or not the refill response 114A, 114B has changed the field “Refills” 1012.24, which is a changed or added field from step 1160, to a positive whole number only if the field “Refills” in the refill request 112 was either a blank or “0”. The quality engine 150 indicates on the quality report card the result of the quality engine 150 evaluating whether or not the refill response 114B changed the field “Refills” 1012.24 either when the field “Refills” was not a blank or “0”, or whether or not the refill response 114B was changed to a number that was not a positive whole number. The “Refills” field is not one of the fields of the refill request 112 illustrated in FIG. 5 and as such may be regarded as blank.

The quality engine 150 evaluates whether or not the prescriber 154 added only free text or coded notes to the pharmacy 152 in the “Note to Pharmacy” field (not illustrated), which is a changed or added field from step 1160, of the refill response 114A. The quality engine 150 indicates the result of evaluating whether or not the prescriber 154 added only free text or coded notes to the pharmacy 152 in the “Note to Pharmacy” field.

The quality engine 150 evaluates whether or not the prescriber 154 added or changed text in the “Supervising Prescriber Filed” field (not illustrated), which is a changed or added field from step 1160, of the refill response 114A. The quality engine 150 indicates the result of evaluating whether or not the prescriber 154 added or changed text in the “Supervising Prescriber Filed” field (not illustrated) of the refill response 114A.

The quality engine 150 evaluates whether or not the prescriber 154 only added diagnosis information to the “Medication Segment” field (not illustrated), which is a changed or added field from step 1160, of the refill response 112. The quality engine 150 indicates the result of evaluating whether or not the prescriber 154 only added diagnosis information to the “Medication Segment” field (not illustrated) of the refill response 112.

The quality engine 150 evaluates whether or not the prescriber 154 added drug prior authorization information to the “Medication Segment” field (not illustrated) of the refill response 114A. The quality engine 150 indicates the result of evaluating whether or not the prescriber 154 added drug prior authorization information to the “Medication Segment” field (not illustrated) of the refill response 114A.

For a “Request Approval Status” 1012.23 of “A” only the fields described above can be changed or added. The quality engine 150 evaluates whether any other fields have been added or changed and whether or not each of the other fields of the refill request 112 have been echoed back exactly as sent in the refill request 112. Each of the fields of the refill request 112 that are not included above are fields that must be echoed back from step 1140. The quality engine 150 indicates the result of the quality engine 150 evaluating whether any other fields have been added or changed and whether or not each of the other fields of the refill request 112 have been echoed back exactly as sent in the refill request 112.

For a “Request Approval Status” 1012.23 of “C” the following are the quality issues. The prescriber 154 can add or change “Date Written” 1012.22 from the refill request 112. The “Date Written” 1012.22 field is changed or added field from step 1160. The quality engine 150 evaluates whether or not the date populated in the “Date Written” 1012.22 is less than two days from the date of the prescriber generated REFRES message, and then the quality engine 150 adds the result of the evaluation to the quality report card. The quality issue is whether or not the “Date Written” 1012.22 is less than two days from the date of the prescriber generated REFRIES message.

The prescriber 154 must include the required field “Substitutions Allowed” 1012.11, which is a required field from step 1150, in the refill response 114A. The prescriber 154 may change the substitution code to match with the intent of the prescription. The prescriber 154 can only send in the refill response 114A a “0”, which means generic substitution permitted or a “1”, which means dispense as written value in the refill response 114A. However, in the refill request 112 pharmacies 152 are may send values from 0 to 8 (except 6). The prescriber 154 must convert any value other than 0 or 1 in the refill request 112 to a 0 or a 1 in the refill response 114A. When the prescriber 154 receives a code of “7”, which means substitution not allowed that a brand drug mandated by law, the prescriber 154 should populate the refill response with a 1, which means substitution code not allowed by prescriber. All other codes received in the refill request 112 should be converted to a 0. The quality engine 150 evaluates whether or not the rules described above are followed by the prescriber 154 by examining the “Substitutions Allowed” 1012.11 field in the refill response 114A and the “Substitutions Allowed” 512.11 field in the refill request 112.

The quality engine 150 indicates on the quality report card the result of the quality engine 150 evaluating whether or not the refill response 114A refill response 114A follows the rules described above in relation to the field “Substitutions Allowed” 1012.11.

The quality engine 150 evaluates whether or not the refill response 114A, 114B has changed the field “Refills” 1012.24, which is a changed or added field from step 1160. For a “Request Approval Status” 1012.23 of “C” the following are the quality issues. The field “Refills” 1012.24 may be changed from a non-zero positive whole refill number to another non-zero positive whole number in field “Refills” 1012.24. In embodiments, the “Refills” 1012.24 may only be changed to a larger non-zero whole refill number. For a “Request Approval Status” 1012.23 of “A” the following are the quality issues. The field “Refills” 1012.24 may be changed from blank to a one and from zero to one. The quality engine 150 indicates on the quality report card the result of the quality engine 150 evaluating the quality issues for “Request Approval Status” 1012.23 of “C” or the result of the quality engine 150 evaluating the quality issues for “Request Approval Status” 1012.23 of “A”. The “Refills” field is not one of the fields of the refill request 112 illustrated in FIG. 5 and as such, in some embodiments, may be regarded as blank.

The quality engine 150 evaluates whether or not the prescriber 154 added only free text or coded notes to the pharmacy 152 in the “Note to Pharmacy” field (not illustrated), which is a changed or added field from step 1160, of the refill response 114A. The quality engine 150 indicates on the quality report card the result of evaluating whether or not the prescriber 154 added only free text or coded notes to the pharmacy 152 in the “Note to Pharmacy” field.

The quality engine 150 evaluates whether or not the prescriber 154 added or changed text in the “Supervising Prescriber Filed” field (not illustrated), which is a changed or added field from step 1160, of the refill response 114A. The quality engine 150 indicates the result on quality report card of evaluating whether or not the prescriber 154 added or changed text in the “Supervising Prescriber Filed” field (not illustrated) of the refill response 114A.

The quality engine 150 evaluates whether or not the prescriber 154 only added diagnosis information to the “Medication Segment” field (not illustrated), which is a changed or added field from step 1160, of the refill response 112. The quality engine 150 indicates on the quality report card the result of evaluating whether or not the prescriber 154 only added diagnosis information to the “Medication Segment” field (not illustrated) of the refill response 112.

The quality engine 150 evaluates whether or not the prescriber 154 added drug prior authorization information to the “Medication Segment” field (not illustrated), which is a changed or added field from step 1160, of the refill response 114A. The quality engine 150 indicates on the quality report card the result of evaluating whether or not the prescriber 154 added drug prior authorization information to the “Medication Segment” field (not illustrated) of the refill response 114A.

The quality engine 150 evaluates whether or not a “Prescriber Order Number” 1012.3, which is a changed or added field from step 1160, is included in the refill response 114A for “Request Approval Status” 1012.23 of “A” or “C”. The quality engine 150 indicates on the quality report card the result of evaluating whether or not a “Prescriber Order Number” 1012.3 is included in the refill response 114A for “Request Approval Status” 1012.23 of “A” or “C”.

For a “Request Approval Status” 1012.23 of “C” only the fields described above in relation to “Request Approval Status” 1012.23 of “C” can be changed or added. All the other fields of the refill request 112 are field that must be echoed back from step 1140. The quality engine 150 evaluates whether any other fields have been added or changed and whether or not each of the other fields of the refill request 112 have been echoed back exactly as sent in the refill request 112. Each of the fields of the refill request 112 that are not included above are fields that must be echoed back from step 1140. The quality engine 150 indicates the result of the quality engine 150 evaluating whether any other fields have been added or changed and whether or not each of the other fields of the refill request 112 have been echoed back exactly as sent in the refill request 112.

For a “Request Approval Status” 1012.23 of “D” the following are the quality issues.

The quality engine 150 evaluates whether or not each field of the refill request 112 is echoed back exactly in the refill response 114B except for two fields, “Note to Pharmacy” (not illustrated), which is a changed or added field from step 1160, and “Denial Code” (not illustrated), which is a changed or added field from step 1160, that may be changed by the prescriber 154. The fields that must be echoed back are fields from step 1140. The quality engine 150 indicates on the quality report card the result of evaluating whether or not each field of the refill request 112 is echoed back exactly in the refill response 114B except for two fields, “Note to Pharmacy” (not illustrated), and “Denial Code” (not illustrated), that may be changed by the prescriber 154.

The quality engine 150 evaluates whether or not if the prescriber 154 added a “Denial Code” (not illustrated) to the refill response 114B that the “Denial Code” is an approved list of denial codes from the reference sources 140. The quality engine 150 indicates on the quality report card the result of evaluating whether or not if the prescriber 154 added a “Denial Code” (not illustrated) to the refill response 114B that the “Denial Code” is an approved list of denial codes from the reference sources 140.

For a “Request Approval Status” 1012.23 of “N” the following are the quality issues.

The quality engine 150 performs step 1140 by evaluating whether or not the refill response 114B echoes back exactly all fields of the refill request 112 except for a “Note to Pharmacy” (not illustrated), which the prescriber 154 is permitted to add a note, and “Refills” 1012.24, which the prescriber 154 is required to set to 0, and which is a added or changed field of step 1160. The quality engine 150 indicates on the quality report card the result of evaluating whether or not the refill response 114B echoes back exactly all fields of the refill request 112 except for a “Note to Pharmacy” (not illustrated), and “Refills” 1012.24.

The quality engine 150 performs step 1150 by evaluating whether or not the “Refills” 1012.24 field of the refill response 114B is set to 0. The quality engine 150 indicates on the quality report card the result of evaluating whether or not the “Refills” 1012.24 field of the refill response 114B is set to 0.

The quality engine 150 performs step 1160 by evaluating whether or not a “RX Reference Number” 1012.4 is included in the refill response 114A when a “RX Reference Number” 512.4 was included in the refill request 112. In embodiments, “RX Reference Number” 1012.4 is a required field. The quality engine 150 indicates on the quality report card the result of evaluating whether or not a “RX Reference Number” 1012.4 is included in the refill response 114A when a “RX Reference Number” 512.4 was included in the refill request 112.

The method 1100 may end after step 1160.

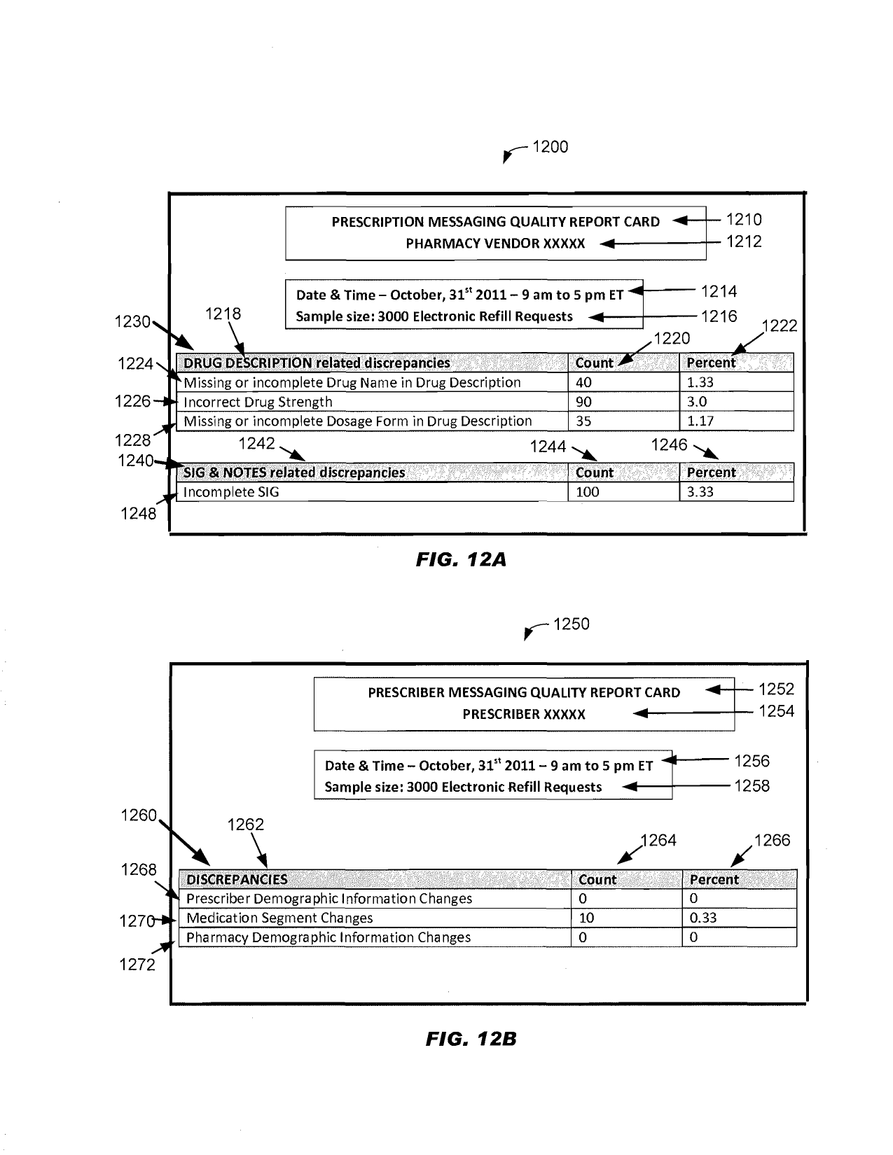

FIG. 12A is an illustration of an example of a pharmacy quality report card. The quality report card 1200 includes a title 1210, a pharmacy vendor 1212, a date and time 1214, a sample size 1216, and one or more tables for quality issues. The title 1210 may be a title that identifies the quality report card 1200. The pharmacy vendor 1212 may be information that can be used to identify the pharmacy which is the subject of the quality report card 1200. For example, pharmacy vendor 1212 may be the same as pharmacy 512.14 of FIG. 5. Date and time 1214 may indicate a period of time when the sample size 1216 was gathered for the pharmacy vendor 1212. In embodiments, the date and time may include a date and time when the quality report card 1200 was generated. Sample size 1216 may be an indication of the size of the sample for the indicated type of message, which here is an electronic refill request

As illustrated in FIG. 12A there are two tables one for drug description related discrepancies 1230, and one for SIG & Notes related discrepancies 1240. Drug description related discrepancies table 1230 includes a column for drug description related discrepancies 1218, a column for count 1220, and a column for percentage 1222. There are three rows in table 1230. Row 1224 is for missing or incomplete drug name in drug description. For example, referring to FIG. 5, the drug name Amoxicillin may be missing or misspelled in 514.5. Row 1226 is for incorrect drug strength. For example, referring to FIG. 5, the strength 500 514.6 may be missing or a number other than 500. Row 1228 is for missing or incomplete dosage form in drug description. For example, referring to FIG. 5, the oral capsule may be missing or incorrect in 514.5. SIG & Notes related discrepancies table 1240 includes a column for sig & notes related discrepancies 1242, a column for count 1244, and a column for percentage 1246. There is one row 1248 in table 1240. Row 1248 is for incomplete SIG. For example, referring to FIG. 5, “take 1 every four hours” 514.12 may have been missing or incomplete.

FIG. 12B is an illustration of an example of a prescriber messaging quality report card 1250. The quality report card 1250 includes a title 1252, a prescriber 1254, a date and time 1256, a sample size 1258, and one or more tables for quality issues. The title 1252 may be a title that identifies the quality report card 1250. The prescriber 1254 may be information that can be used to identify the prescriber which is the subject of the quality report card 1200. For example, prescriber 1254 may be the same as prescriber 1014.15 of FIG. 10. Date and time 1256 may indicate a period of time when the sample size 1258 was gathered for the prescriber 1254. In embodiments, the date and time may include a date and time when the quality report card 1250 was generated. Sample size 1258 may be an indication of the size of the sample for the indicated type of message, which here are prescriber messages.

As illustrated in FIG. 12B there is one table for discrepancies 1260. Discrepancies table 1260 includes a column for discrepancies 1262, a column for count 1264, and a column for percentage 1266. There are three rows in table 1260. Row 1268 is for prescriber demographic information changes. For example, referring to FIG. 10, the prescriber information 1014.15 may be changed from what was sent in 514.15. Row 1270 is for medication segment changes. For example, referring to FIG. 10, the prescription 1014.5 may have been changed from what was sent in 514.5. Row 1272 is for pharmacy demographic information changes. For example, referring to FIG. 10, the pharmacy information 1014.14 may be changed from what was sent in 514.14.

The quality report card may include only some of the quality issues. The quality report card may not include a sample size. The quality report card may not include a percent or a count. In embodiments, the quality report card only includes an indication that quality issues were detected with specific fields. In embodiments, the quality report card may include the actual data that raised quality issues.

The quality control system provides the benefit that pharmacies, prescribers, and technology venders can monitor the quality of their interactions with one another and use the quality report card to improve the quality of their interactions.

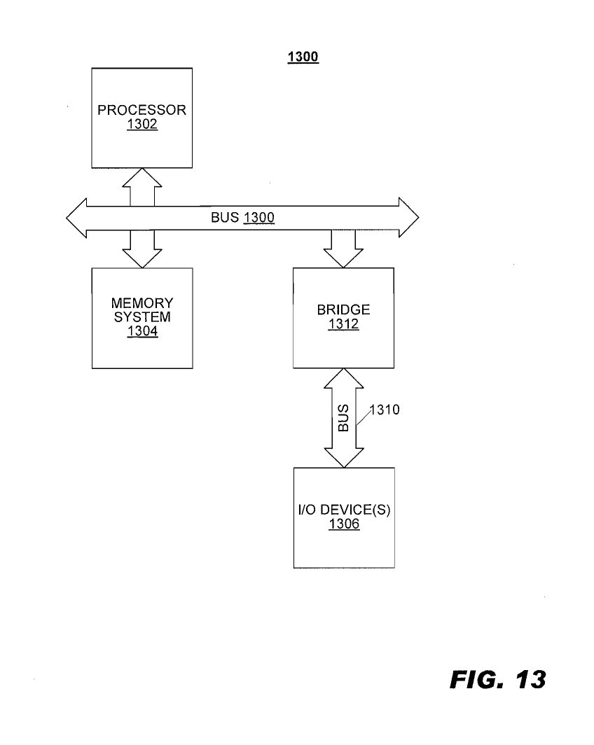

FIG. 13 is a simplified functional block diagram of a computer system 1300. The quality control system can be implemented in hardware, software or some combination thereof.

As shown in FIG. 13, the computer system 1300 includes a processor 1302, a memory system 1304 and one or more input/output (I/O) devices 1306 in communication by a communication ‘fabric.’ The communication fabric can be implemented in a variety of ways and may include one or more computer buses 1308, 1310 and/or bridge devices 1312 as shown in FIG. 13. The I/O devices 1306 can include network adapters and/or mass storage devices. Referring to FIGS. 2 and 13, the computer system 1300 may retrieve interactions over the I/O devices 1306 and/or Memory System 1304 for quality control checking and write a quality report card to Memory System 1304 and/or the I/O Devices 1306. The quality issues 120, quality standards 130, reference sources 140, quality engine 150, quality report card 160 may reside on memory system 1304 and/or on I/O devices 1306. For example, the reference sources 140 may include a database of drug products. The database may be organized and accessible according to commercial available database products. The database of drug products may reside on a mass storage device that is part of the memory system 1304, or may reside on a mass storage device that is accessible via the communication fabric and part of the I/O devices 1306, which may be either local such as a hard disk in the same room as the processor 1302 or may be located remotely such as in a memory system such as a hard disk remotely located in a service center. The communication fabric may be in communication with many networks including the Internet and local area networks. The quality control system 100 may store the quality report card 160 and/or forward the quality report card 160 either locally or remotely over the communication fabric.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium, which may be in a physical form.

Although described in connection with preferred embodiments thereof, it will be appreciated by those skilled in the art that additions, deletions, modifications, and substitutions not specifically described may be made without departure from the spirit and scope of the invention as defined in the appended claims.

What is claimed is:

1. A method on a computer for quality control checking, the method comprising:
determining an interaction between a pharmacy and a prescriber;
evaluating the interaction for each of a plurality of quality issues; and
generating a quality report card to indicate the results of evaluating the interaction for each of the plurality of quality issues.

2. The method of claim 1, wherein determining an interaction comprises:
selecting an electronic refill request originating from a pharmacy;
searching for an electronic response originating from a prescriber that matches the retrieved electronic refill request; and
if there is a matching electronic response, then the selected electronic refill request and the matching electronic response are the interaction, otherwise the electronic refill request is the interaction.

3. The method of claim 2, wherein if there is a matching electronic response comprises:
if there is a matching electronic response and the matching electronic response indicates a denial of the refill request with a new prescription, then searching for an electronic new prescription corresponding to the electronic refill request, and if there is an electronic new prescription corresponding to the electronic refill request, then the selected electronic refill request, the matching electronic response, and the electronic new prescription corresponding to the electronic refill request are the interaction, otherwise the selected electronic refill request and the matching electronic response are the interaction.

4. The method of claim 1, wherein the interaction comprises an electronic refill request that comprises a prescription field, and wherein one of the plurality of quality issues is whether or not the prescription field matches one of a plurality of stored drug products, and wherein the method further comprises:
determining whether the prescription field matches one of a plurality of stored drug products; wherein generating further comprises:
generating the quality report card to indicate whether or not the prescription field matches one of a plurality of stored drug products.

5. The method of claim 1, wherein the interaction comprises an electronic refill request that comprises a free text description field and a drug strength field, and wherein one of the plurality of quality issues is whether or not the drug strength field matches a drug strength in the free text drug description field, and wherein the method further comprises:
verifying that the drug strength field matches the drug strength in the free text drug description field; and
wherein generating further comprises:
generating the quality report card to indicate whether or not the drug strength field matches the drug strength in the free text drug description field.

6. The method of claim 1, wherein the interaction comprises an electronic refill request that comprises a sender message identification, and a refill response that comprises the sender message identification and a request approval status, and wherein one of the plurality of quality issues is whether or not the request approval status of the refill response is valid, and wherein the method further comprises:
evaluating whether or not the request approval status is valid; and
wherein generating a quality report card further comprises:
generating a quality report card to indicate whether or not the request approval status is valid.

7. The method of claim 1, wherein the interaction comprises an electronic refill request comprising a sender message identification and one or more fields that must be echoed back, and a electronic refill response comprising the sender message identification, and wherein one of the plurality of quality issues is whether or not the electronic refill response echoes back the fields that must be echoed back, and wherein the method further comprises:
evaluating whether or not the refill response echoes back the one or more fields that must be echoed back; and
wherein generating a quality report card further comprises:
generating a quality report card to indicate whether or not the refill response echoes back the one or more fields that must be echoed back.

8. The method of claim 7, wherein the electronic refill response further comprises a request approval status, and wherein the one or more fields that must be echoed back are based on the request approval status.

9. The method of claim 1, wherein the interaction comprises an electronic refill response comprising one or more fields that are required, and wherein one or more of the plurality of quality issues is whether or not the electronic refill response meets one or more quality issue for the one or more fields that are required, and wherein the method further comprises:
evaluating whether or not the electronic refill response meets one or more quality issues for the one or more fields that are required; and
wherein generating a quality report card further comprises:
generating a quality report card to indicate whether or not the electronic refill response meets one or more quality issue for the one or more fields that are required.

10. The method of claim 9, wherein the electronic refill response further comprises a request approval status, and wherein the one or more fields that are required are based on the request approval status.

11. The method of claim 1, wherein the interaction comprises an electronic refill request comprising a sender message identification, and a electronic refill response comprising the sender message identification and one or more fields that are changed from the electronic refill request or fields not part of the refill request, and wherein one of the plurality of quality issues is whether or not the one or more fields that are changed from the electronic refill request or fields not part of the refill request meet one or more quality issues, and wherein the method further comprises:
evaluating whether or not the one or more fields that are changed from the electronic refill request or fields not part of the refill request meet one or more quality issues; and
wherein generating a quality report card further comprises:
generating a quality report card to indicate whether or not the one or more fields that are changed from the electronic refill request or fields not part of the refill request meet one or more quality issues.

12. The method of claim 9, wherein the one or more fields that are required comprises a substitutions allowed field, and wherein evaluating whether or not the refill response meets one or more quality issues for the one or more fields that are required, comprises:
evaluating whether or not the substitution allowed field contains a valid value; and wherein generating a quality report card further comprises:
generating a quality report card to indicate whether or not the substitution allowed field contains a valid value.

13. The method of claim 1, wherein evaluating comprises:
evaluating the interaction for each of a plurality of quality issues, and for at one of the plurality of quality issues, evaluating whether or not the interaction meets a quality standard; and
generating a quality report card to indicate the results of evaluating the interaction for each of the plurality of quality issues, and to indicate whether or not the interaction meets a quality standard.

14. The method of claim 1, wherein determining comprises:
determining interactions that comprise a report target party; and, wherein evaluating comprises:
evaluating the determined interactions for each of a plurality of quality issues; and wherein generating comprises:
generating a quality report card to indicate the results of evaluating the determined interactions for each of the plurality of quality issues, wherein the report target party is at least one of a pharmacy, a prescriber, a pharmacy technology vender, or a prescriber technology vender.

15. The method of claim 14, wherein determining comprise:
determining interactions that comprise a report target party for a date range.

16. A non-transitory computer program product, comprising a computer usable medium having a computer readable program code embodied therein, said computer readable program code adapted to be executed to implement a method of quality control checking, said method comprising:
determining an interaction between a pharmacy and a prescriber;
evaluating the interaction for each of a plurality of quality issues; and
generating a quality report card to indicate the results of evaluating the interaction for each of the plurality of quality issues.

17. A computer system for quality control checking, the system comprising: a process adapted to:
determine an interaction between a pharmacy and a prescriber;
evaluate the interaction for each of a plurality of quality issues; and
generate a quality report card to indicate the results of evaluating the interaction for each of the plurality of quality issues.

18. The computer system of claim 17, wherein determine an interaction comprises:
select an electronic refill request originating from a pharmacy;
search for an electronic response originating from a prescriber that matches the retrieved electronic refill request; and
if there is a matching electronic response, then the selected electronic refill request and the matching electronic response are the interaction, otherwise the electronic refill request is the interaction.

19. The method of claim 17, wherein the interaction comprises an electronic refill response comprising one or more fields that are required, and wherein one or more of the plurality of quality issues is whether or not the electronic refill response meets one or more quality issue for the one or more fields that are required, and wherein the process is further adapted to:
evaluate whether or not the electronic refill response meets one or more quality issues for the one or more fields that are required; and
wherein generate a quality report card further comprises:
generating a quality report card to indicate whether or not the electronic refill response meets one or more quality issue for the one or more fields that are required.

20. The method of claim 19, wherein the electronic refill response further comprises a request approval status, and wherein the one or more fields that are required are based on the request approval status.
